(19) United States
(12) Patent Application Publication
(10) Pub. No.: US 2013/0183651 A1
(43) Pub. Date: Jul. 18, 2013

(54) SERVER, LEARNING TERMINAL APPARATUS, AND LEARNING CONTENT MANAGING METHOD

(71) Applicant: SONY CORPORATION, Tokyo (JP)

(72) Inventors: Kazuhiro TAKAHASHI, Tokyo (JP); Hiroshi KAGAWA, Kanagawa (JP); Yuko SUZUKI, Kanagawa (JP); Koji NAKANISHI, Kanagawa (JP); Shoko HASUO, Kanagawa (JP); Munehiro YOSHIDA, Tokyo (JP); Makoto YAMADA, Kanagawa (JP)

(73) Assignee: SONY CORPORATION, Tokyo (JP)

(21) Appl. No.: 13/681,790

(22) Filed: Nov. 20, 2012

(30) Foreign Application Priority Data
Jan. 13, 2012 (JP) 2012004935

(51) Int. Cl. G09B 5/06

(52) U.S. Cl. CPC G09B 5/06
USPC 434/350

(57) ABSTRACT

There is provided a server including a teaching material storage unit configured to store teaching material data, notebook templates, and link information indicating associations between the teaching material data and the notebook templates, and a transmission unit configured to transmit the teaching material data and the notebook templates associated with the teaching material data to a learning terminal apparatus according to a request from the learning terminal apparatus. The link information indicates association of a notebook template selected by a teacher for a designated page of the teaching material data. The notebook template is superimposed on another layer and displayed in the learning terminal apparatus.

### BACKGROUND

The present disclosure relates to a server, a learning terminal apparatus, and a learning content managing method.

Recently, electronic notebooks that enable information to be freely written as in a paper notebook and digitalize the written information have been known. For example, in Japanese Patent Application Publication No. 2001-34260A, an electronic notebook that displays a base image such as conference materials on a display unit and displays a written object as an input object on the display unit when a user writes with a touch pen on the image has been proposed.

On the other hand, recently, electronic books have rapidly become widespread. Although content serving as an electronic book target is mainly works of literature, the digitization of content to be used in educational institutions such as specialized books or learning materials is also predicted to be great in the future.

### SUMMARY

Here, when the digitalization of content to be used in the educational institutions has been advanced, the construction of an effective learning system using electronic data of learning materials is desired.

For example, lessons may be taught in a classroom using a display apparatus on which electronic data of learning materials is displayed and an electronic notebook on which the electronic data of the learning materials can be freely written. In addition, a teacher can read the writing of a student in real time by transmitting an input object freely written by the student on the electronic notebook to an information processing apparatus used by the teacher.

however, because the object freely written by the student is directly digitalized in the electronic notebook of Japanese Patent Application Publication No. 2001-34260, it is necessary for the teacher to separately read objects input by students. Because the time and effort for the separate reading tasks are necessary, it is difficult to efficiently teach a lesson.

In addition, in learning content for an e-learning system that also provides education to a remote location via a network, the layout of question and answer fields is pre-fixed. Consequently, a degree of freedom in learning content creation is low and the low degree of freedom is a limitation for an author (for example, a teacher) who wants to create efficient learning content.

As described above, the reading task is time-consuming when the student can freely write on the electronic notebook, and the degree of freedom in the learning content creation is low when the layout of question and answer fields is pre-fixed, and such a low degree of freedom is a limitation for the author.

It is desirable to provide a novel and improved server, learning terminal apparatus, and learning content managing method that can perform customization to more effective learning content by selecting a notebook template.

According to an embodiment of the present disclosure, there is provided a server including a teaching material storage unit configured to store teaching material data, notebook templates, and link information indicating associations between the teaching material data and the notebook templates, and a transmission unit configured to transmit the teaching material data and the notebook templates associated with the teaching material data to a learning terminal apparatus according to a request from the learning terminal apparatus. The link information indicates association of a notebook template selected by a teacher for a designated page of the teaching material data. The notebook template is superimposed on another layer and displayed in the learning terminal apparatus.

According to an embodiment of the present disclosure, there is provided a learning terminal apparatus including a reception unit configured to receive teaching material data and a notebook template associated by a teacher with the teaching material data from a server, a display control unit configured to control the teaching material data to be displayed in a first display region and control the notebook template associated with the teaching material data displayed in the first display region to be displayed in a second display region, and an input unit configured to receive a data input by a student for the second display region. The display control unit controls a layer based on the student input data received by the input unit to be displayed while superimposing the notebook template.

According to an embodiment of the present disclosure, there is provided a learning content managing method including transmitting teaching material data and a notebook template associated with the teaching material data to a learning terminal apparatus by extracting the teaching material data and the notebook template from a teaching material storage unit, which stores teaching material data, notebook templates, and link information indicating associations between the teaching material data and the notebook templates, according to a request from the learning terminal apparatus. The link information indicates association of a notebook template selected by a teacher for a designated page of the teaching material data. The notebook template is super posed on another layer and displayed in the learning terminal apparatus.

In accordance with the embodiments of the present disclosure described above, it is possible to perform customization to more effective learning content by selecting a notebook template.

### BRIEF DESCRIPTION OF THE DRAWINGS

FIG. 1 is a diagram illustrating an overview of a learning system in accordance with an embodiment of the present disclosure;

FIG. 2 is a block diagram illustrating a basic configuration of a terminal managing apparatus in accordance with this embodiment;

FIG. 3 is a block diagram illustrating a configuration of a server in accordance with this embodiment;

FIG. 4 is a diagram illustrating databases (DBs) stored by a content storage unit in accordance with this embodiment;

FIG. 5 is a block diagram illustrating a configuration of a learning terminal in accordance with this embodiment;

FIG. 6 is a diagram illustrating a use example of the learning terminal in accordance with this embodiment;

FIG. 7 is a conceptual diagram illustrating three layers included in notebook data of work-sheet content in accordance with this embodiment;

FIG. 8 is a conceptual diagram illustrating three layers included in notebook data of test content in accordance with this embodiment;

FIG. 9 is a diagram illustrating data input by a student according to a notebook template in accordance with this embodiment;

FIG. 10 is a diagram illustrating an example of test question data and a notebook template of test content in accordance with this embodiment;

FIG. 11 is a sequence diagram illustrating a notebook template selection process in accordance with this embodiment;

FIG. 12 is a diagram illustrating an example of a plurality of notebook templates in accordance with this embodiment;

FIG. 13 is a conceptual diagram illustrating a relationship of teaching material data, notebook templates, and notebook data in accordance with this embodiment;

FIG. 14 is a sequence diagram illustrating a lesson start process in accordance with this embodiment;

FIG. 15 is a sequence diagram illustrating a red-pen input process in accordance with this embodiment;

FIG. 16 is a sequence diagram illustrating an automatic scoring process in accordance with this embodiment;

FIG. 17 is a conceptual diagram illustrating a correspondence relationship between a comment page of test questions and test correct answer data in accordance with this embodiment;

FIG. 18 is a diagram illustrating an entire configuration of the learning system that switches a notebook template in accordance with this embodiment;

FIG. 19 is a sequence diagram illustrating a notebook template request process from the learning terminal in accordance with this embodiment; and

FIG. 20 is a sequence diagram illustrating a notebook template request process from the terminal managing apparatus in accordance with this embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Description will be given in the following order.

1. Overview of Learning System in Accordance with Embodiment of Present Disclosure

2. Basic Configuration

2-1. Terminal Managing Apparatus

2-2. Server

2-3. Learning Terminal

3. Operation Processing

3-1. Notebook Template Selection

3-2. Lesson Start Process

3-3. Red-Pen Input Process

3-4. Automatic Scoring Process

4. Switching of Notebook Template

5. Conclusion

In addition, the learning system in accordance with the embodiment of the present disclosure illustrating details of the above-described “1. Overview of Learning System in Accordance with Embodiment of Present Disclosure” to “4. Switching of Notebook Template” includes:

a server 40 including:

(A) a teaching material storage unit (a teaching material DB 43), which stores teaching material data, notebook templates, and link information indicating associations between the teaching material data and the notebook templates; and

(B) a transmission unit (a communication interface (I/F) 401), which transmits the teaching material data and the notebook templates associated with the teaching material data to a learning terminal apparatus according to a request from the learning terminal apparatus,

(C) wherein the link information indicates association of a notebook template selected by a teacher for a designated page of the teaching material data, and

(D) wherein the notebook template is superimposed on another layer and displayed in the learning terminal apparatus, and a learning terminal apparatus (a learning terminal 10) including:

(E) a reception unit (a communication IN 204), which receives teaching material data and a notebook template associated by a teacher with the teaching material data from the server;

(F) a display control unit 105 or 205, which controls the teaching material data to be displayed in a first display region (a touch panel 150) and controls the notebook template associated with the teaching material data displayed in the first display region to be displayed in a second display region (a touch panel 250); and

(G) an input unit (an operation input unit 207), which receives data input by a student for the second display region,

(H) wherein the display control unit controls a layer based on the student input data received by the input unit to be displayed while superimping the notebook template.

### 1. OVERVIEW OF LEARNING SYSTEM IN ACCORDANCE WITH EMBODIMENT OF PRESENT DISCLOSURE

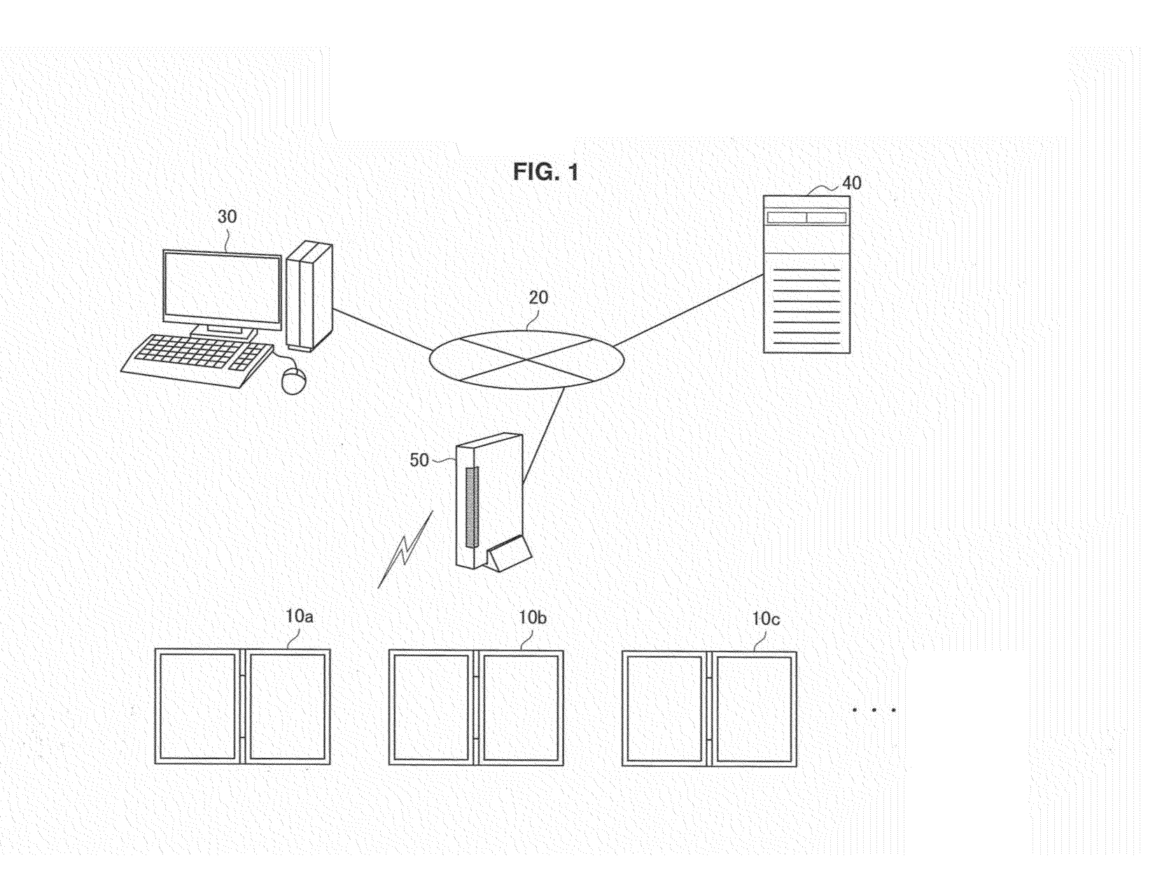

First, the overview of the learning system in accordance with the present disclosure will be described with reference to FIG. 1. As illustrated in FIG. 1, the learning system in accordance with this embodiment has a plurality of learning terminals 10a, 10b, and 10c, a terminal managing apparatus 30, and the server 40. The learning terminals 10a, 10b, and 10c are referred to hereinafter as the learning terminal 10 when it is not necessary to distinguish the learning terminals 10a, 10b, and 10c as individual learning terminals.

The learning terminal 10 and the terminal managing apparatus 30 are connected to the server 40 via a dedicated network 20. In the example illustrated in FIG. 1, the learning terminal 10 is connected to the dedicated network 20 via wireless communication (for example, wireless fidelity (Wi-Fi)) with an access point 50.

The dedicated network 20, for example, is a local area network (LAN) for connecting communication apparatuses installed within a school.

When the learning system illustrated in FIG. 1 is applied to lessons in a classroom, the teacher can manage the learning terminals 10 used by the students using the terminal managing apparatus 30. For example, the learning terminals 10 can be caused to display textbook data designated by the terminal managing apparatus 30 or notebook data written by the students on the learning terminals 10 can be browsed by the terminal managing apparatus 30.

Learning content including textbook data and notebook data is stored in the server 40.

Here, when the students have freely written in notebook regions of the learning terminals 10, it is necessary for the teacher to separately read content written the students and hence time and effort are necessary. On the other hand, when the layout of question and answer fields is pre-fixed, the degree of freedom in learning content creation is low and the low degree of freedom is a limitation for a creator such as the teacher.

In the learning system in accordance with the embodiment of the present disclosure, learning content can be easily customized by selecting a notebook template desired to be used by the teacher in lessons from a plurality of notebook templates created in advance according to teaching materials. In addition, the teacher may edit the selected notebook template.

In addition, because the student writes in a determined format when a predetermined notebook template is used in the lesson, writing content of each student can be obtained in a data structure of the same format. Thereby, the server 40 can perform automatic scoring.

Further, it is possible to analyze improvement of an understanding level of the student or to what extent their studies have progressed when a certain notebook template is used based on accumulated writing content (notebook data) of the same format. Thereby, a notebook template more effective for learning can be recommended to the teacher.

Hereinafter, a basic configuration, operation processing, and the like of the learning system in accordance with the above-described embodiment of the present disclosure will be sequentially described.

### 2. BASIC CONFIGURATION

The learning system in accordance with the embodiment of the present disclosure has the learning terminals 10 to be used by the students, the terminal managing apparatus 30 to be used by the teacher, and the server 40 storing learning content as described above. Hereinafter, the configurations of apparatuses will be described in detail using the drawings.

[2-1. Terminal Managing Apparatus]

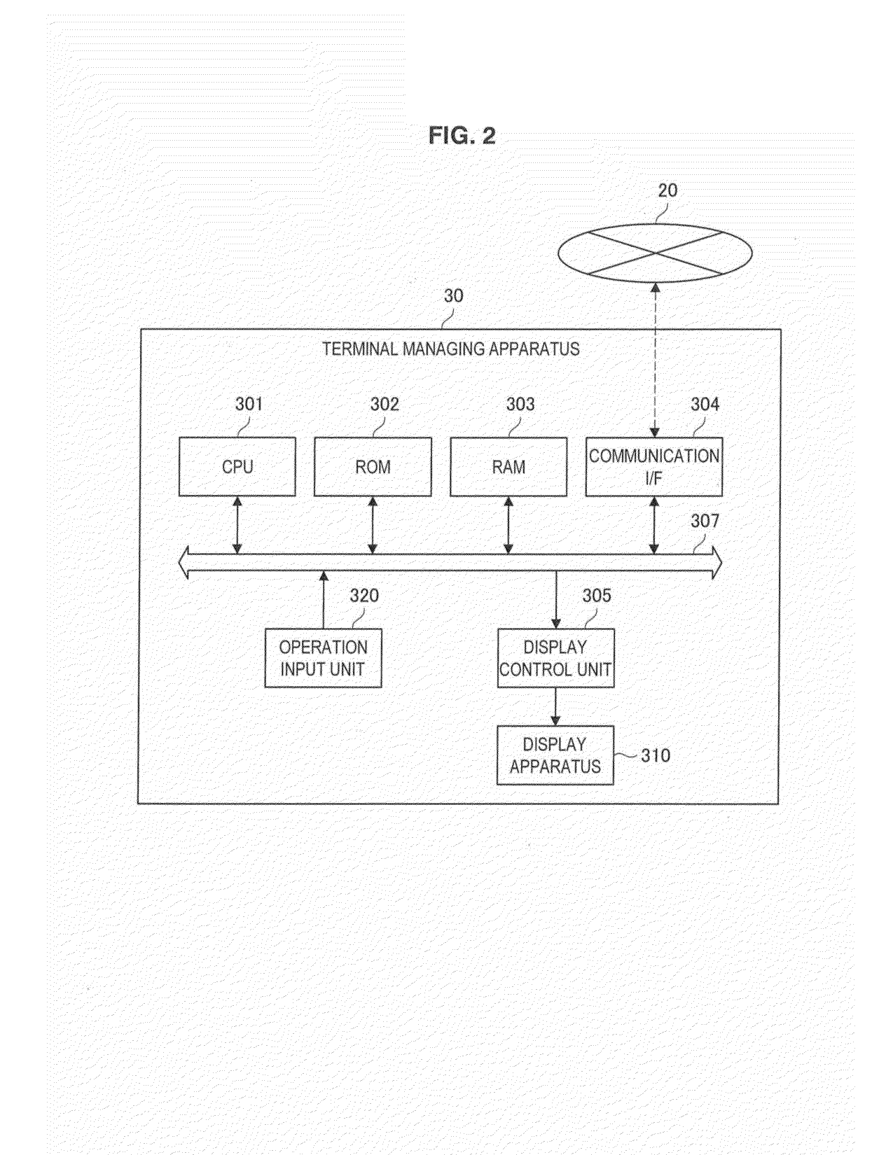

FIG. 2 is a block diagram illustrating a basic configuration of the terminal managing apparatus 30 in accordance with this embodiment. As illustrated in FIG. 2, the terminal managing apparatus 30 has a central processing unit (CPU) 301, a read only memory (ROM) 302, a random access memory (RAM) 303, a communication IF 304, a display control unit 305, and an operation input unit 320. The CPU 301, the ROM 302, the RAM 303, the communication I/F 304, the operation input, unit 320, and the display control unit 305 are mutually connected by a host bus 307 formed by a CPU bus or the like.

The communication I/F 304 transmits and receives data to and from the learning terminal 10 or the server 40 via the dedicated network 20. For example, the communication I/F 304 transmits various commands such as a lesson start command to the learning terminal 10 or receives teaching material data or notebook data of each student from the server 40.

In addition, the communication I/F 304 may transmit correction content for notebook data of each student in the terminal managing apparatus 30 to the server 40.

Further, the communication I/F 304 in accordance with this embodiment receives a plurality of notebook templates corresponding to teaching materials from the server 40, and transmits selection information indicating which notebook template has been selected for each teaching material page to the server 40.

The display control unit 305 generates image data and controls the display apparatus 310 to display the generated image data. For example, the display control unit 305 controls a display of a notebook data list of each student or a display of teaching material data received from the server 40. In addition, the display control unit 305 controls teaching material data and a notebook data list of each student currently used to be displayed in real time during a lesson. Thereby; the teacher can teach a lesson while checking the notebook data of each student.

In addition, the display control unit 305 may display a plurality of notebook templates corresponding to teaching materials and display a learning content editing screen for allowing the teacher to select which notebook template is associated with which page of the teaching materials or edit the selected notebook template.

The display apparatus 310 is implemented by a cathode ray tube (CRT) display apparatus, a liquid crystal display (LCD) apparatus, an organic light emitting diode (OLED) apparatus, or the like.

The operation input unit 320 has a function of detecting an operation by the teacher, and is specifically implemented by a keyboard, a mouse, and the like as illustrated in FIG. 1.

The CPU 301 controls the entire terminal managing apparatus 30 using the ROM 302 or the RAM 303. The ROM 302 stores programs, calculation parameters, and the like to be used by the CPU 301. The RAM 303 temporarily stores a program to be used for execution of the CPU 301, parameters to be appropriately varied in the execution thereof, and the like.

The terminal managing apparatus 30 having the above-described configuration can be used, for example, when the teacher edits learning content for preparing a lesson in a teachers' room or the like before the lesson, in addition to when the teacher manages the learning terminals 10 of the students in a classroom during the lesson.

Here the terminal managing apparatus 30 in accordance with embodiment is not limited to a desktop personal computer (PC) as illustrated in FIG. 1, and may be a notebook PC or a tablet terminal.

In addition, when the terminal managing apparatus 30 has been specialized for use in a classroom, the terminal managing apparatus 30 (teacher console) may be provided to be integrated with the teacher's desk. In this case, the editing of learning content and the like may be performed from the teacher console and another terminal managing apparatus 30 (teaching material editing apparatus) placed in the teachers' room.

[2-2. Server]

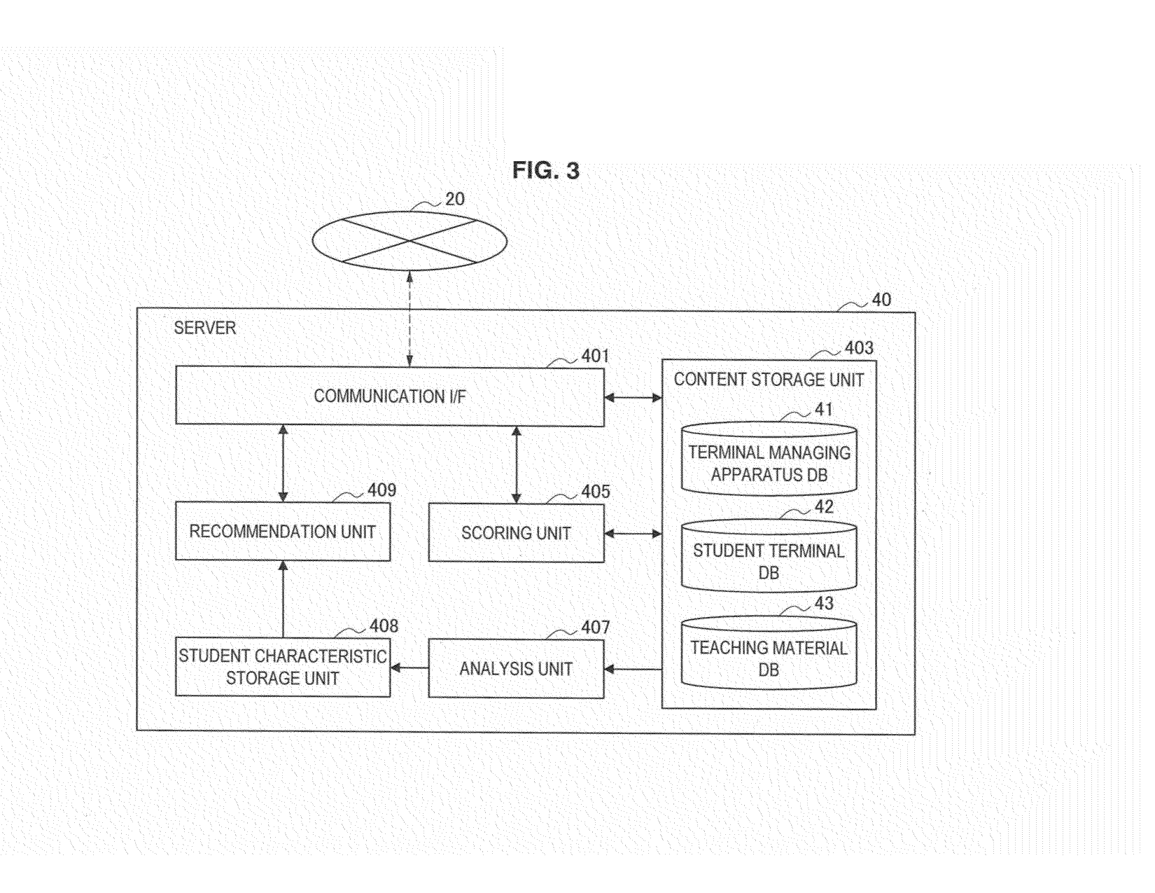

Next, a configuration of the server 40 included in the learning system in accordance with the embodiment of the present disclosure will be described with reference to FIG. 3, FIG. 3 is a block diagram illustrating the configuration of the server 40 in accordance with this embodiment.

As illustrated in FIG. 3, the server 40 has the communication I/F 401, a content storage unit 403, a scoring unit 405, an analysis unit 407, a student characteristic storage unit 408, and a recommendation unit 409.

The communication I/F 401 transmits and receives data to and from the learning terminal 10 or the terminal managing apparatus 30 via the dedicated network 20. For example, the communication I/F 401 transmits teaching material data or notebook data or receives notebook data input by the student from the learning terminal 10 according to a request from the learning terminal 10 or the terminal managing apparatus 30.

In addition, the communication I/F 401 in accordance with this embodiment may transmit a plurality of notebook templates corresponding to teaching materials to the terminal managing apparatus 30 and receive selection information indicating which notebook template has been selected for each page of the teaching materials.

When there is a request for teaching material data and notebook data according to a lesson start from the learning terminal 10, the communication I/F 401 transmits the teaching material data and a notebook template associated with the teaching materials pre-selected by the teacher to the learning terminal 10.

The content storage unit 403 stores various learning content. Specifically, the content storage unit 403 stores a terminal managing apparatus DB 41, a student terminal DB 42, and the teaching material DB 43. Details of each DB stored by the content storage unit 403 will be described later.

According to a scoring request from the learning terminal 10, the scoring unit 405 compares notebook data of a student stored in the content storage unit 403 with test correct answer data and performs scoring. In addition, the scoring unit 405 transmits a scoring result to the learning terminal 10 of a scoring request source.

The analysis unit 407 analyzes notebook data of the students, notebook templates, and teaching material data stored in the content storage unit 403, and analyzes characteristics related to learning of each student. More specifically, for example, the analysis unit 407 analyzes a subject-specific proficiency level (an understanding level or a learning progress level) of each student. The analysis unit 407 stores an analysis result in the student characteristic storage unit 408.

The recommendation unit 409 outputs information useful for guidance such as a subject-specific proficiency level of each student to the terminal managing apparatus 30 or recommended teaching material information, and recommends the information useful for guidance for the teacher, based on student-specific characteristics (analysis results) stored in the student characteristic storage unit 408.

In addition, the recommendation unit 409 provides the teacher or a learning content creator with information (recommendation information) of a notebook template having a high learning effect based on the analysis result. The teacher or the learning content creator can create more effective learning content based on the recommendation information provided from the recommendation unit 409.

(Content Storage Unit 403)

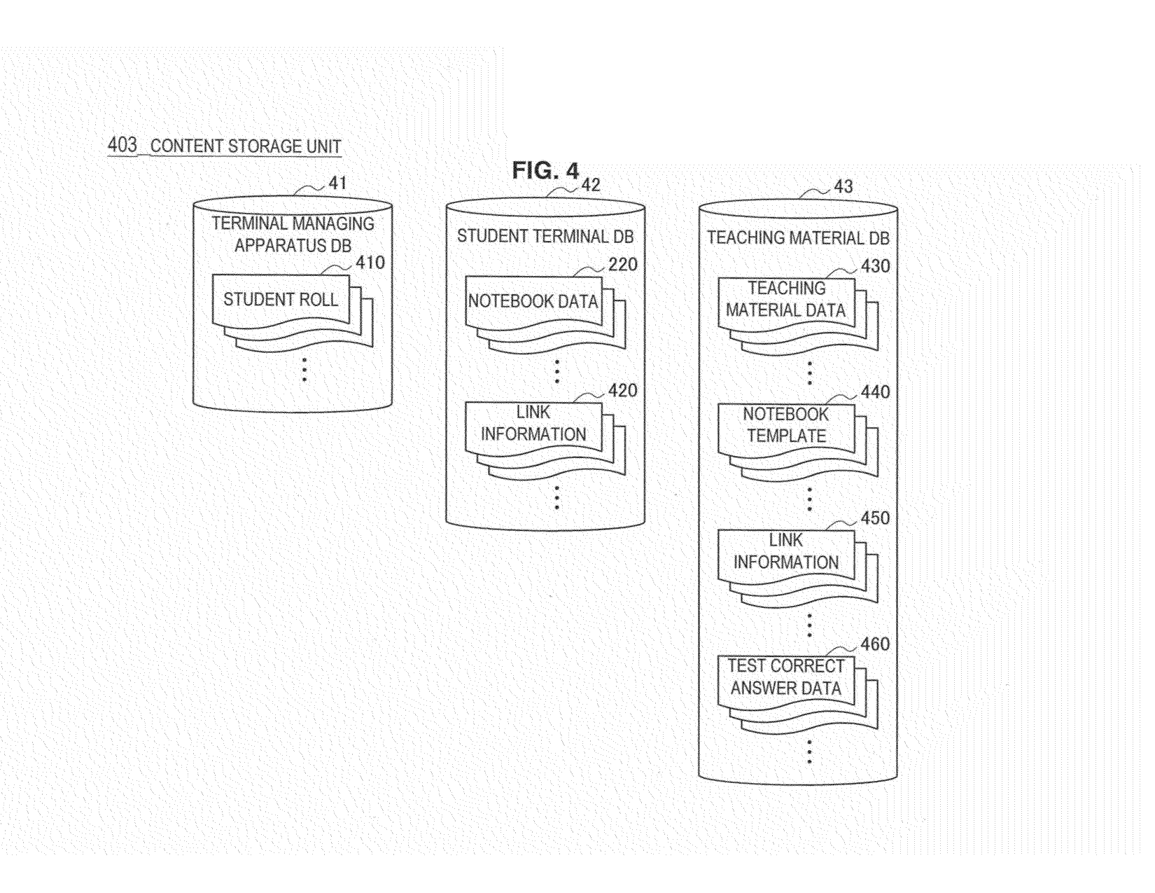

Next, the above-described content storage unit 403 will be specifically described with reference to FIG. 4. FIG. 4 is a diagram illustrating DBs stored by the content storage unit 403 in accordance with this embodiment. As illustrated in FIG. 4, the server 40 has the terminal managing apparatus DB 41, the student terminal DB 42, and the teaching material DB 43.

Terminal Managing Apparatus DB 41

The terminal managing apparatus DB 41 is a DB storing data for the teacher to be used by the teacher in the terminal managing apparatus 30. Specifically, the data for the teacher, for example, is a student roll 410, curriculum data related to a lesson plan, score data, and the like.

Student Terminal DB 42

The student terminal DB 42 is a DB storing notebook data 220 and link information 420 for every student. The notebook data 220 is student input data written by the student in the learning terminal 10. Further, the notebook data 220 also includes an image of a notebook template displayed as a base image when the student has written, an image obtained by drawing a scoring result for the student input data, and the like. A structure of the notebook data 220 will be described in detail in “2-3-4, Structure of Notebook Data.”

The link information 420 is information indicating association between each page of teaching materials and each page of the notebook data 220. The link information 420 is information that is updated when the student has written in the learning terminal 10. For example, the link information 420 newly associates each page of a textbook with a page of notebook data on which the student has written when each page of the textbook has been displayed on the learning terminal 10. Thereby, a page at the notebook side can also be changed in conjunction with a page at the textbook side when the page at the textbook side is changed in the learning terminal 10 or a page at the textbook side can be changed in conjunction with a page at the notebook side when the page at the notebook side is changed.

Teaching Material DB 43

The teaching material DB 43 is a DB storing teaching material data 430 such as textbook data, test question data, and the like, notebook templates 440, link information 450, and test correct answer data 460,

The notebook template 440 is a base image such as a work sheet or a test correct answer sheet corresponding to teaching materials, and includes input components (a text input field, a radio button, or a check box) for allowing the student to input data in a determined format. Specific content of the notebook template 440 will be described in detail in “2-3-4. Structure of Notebook Data.”

The link information 450 is information indicating association between each page of teaching materials and a notebook template. The link information 450 is updated based on selection information by a teacher transmitted from the terminal managing apparatus 30. A process of selecting the notebook template 440 will be described in detail in [3-1, Notebook Template Selection].

[2-3. Learning Terminal]

The learning terminal 10 is a terminal apparatus to be used when the student performs learning, and has a function of displaying teaching material data and receiving writing (data input) by the student. Hereinafter, an internal configuration and a use example for the learning terminal 10 in accordance with this embodiment and a structure of the notebook data 220 displayed on the learning terminal 10 will be sequentially described.

(2-3-1. Internal Configuration)

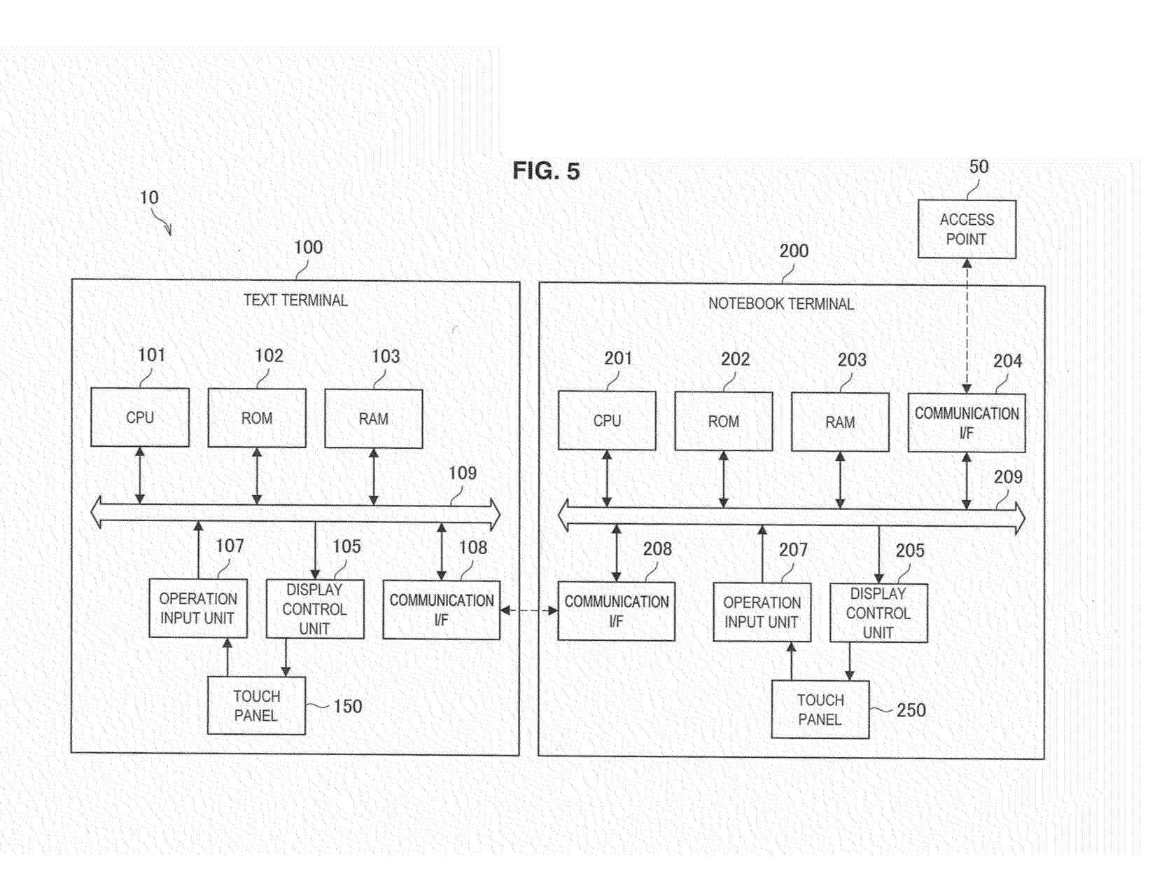

FIG. 5 is a block diagram illustrating the configuration of the learning terminal 10 in accordance with this embodiment. As illustrated in FIG. 5, the learning terminal 10 has a text terminal 100 and a notebook terminal 200.

Text Terminal 100

The text terminal 100 has a CPU 101, a ROM 102, a RAM 103, the display control unit 105, an operation input unit 107, a communication I/F 108, and a touch panel 150. The CPU 101, the ROM 102, the RAM 103, the operation input unit 107, the display control unit 105, and the communication I/F 108 are mutually, connected by a host bus 109 formed by a CPU bus or the like.

The display control unit 105 generates image data and controls the touch panel 150 to display the generated image data. More specifically, the display control unit 105 in accordance with this embodiment controls a display of teaching material data received from the server 40.

The touch panel 150 has a display function of performing a display according to control of the display control unit 105 and an operation input function of receiving an operation input by the student. The display function, for example, is implemented by a CRT display apparatus, an LCD apparatus, an OLED apparatus, or the like. In addition, the operation input function, for example, is implemented by an apparatus that senses a contact position (position information) of a finger, which is an operation body; by adopting an electrostatic capacitive type.

The operation input unit 107 receives an operation input by the student based on information sensed by the touch panel 150. For example, the operation input unit 107 receives an operation of enlarging/reducing teaching material data displayed on the touch panel 150 or an operation of copying the teaching material data (a drag operation of designating a copy range and an operation of flipping the designated range toward the notebook terminal 200).

The communication I/F 108 performs data communication with the notebook terminal 200. In addition, in this embodiment, because the notebook terminal 200 is connected to an outside, the text terminal 100 can perform data communication with the outside via the notebook terminal 200.

The CPU 101 controls the entire text terminal 100 using the ROM 102 or the RAM 103. The ROM 102 stores programs, calculation parameters, and the like to be used by the CPU 101. The RAM 103 temporarily stores a program to be used for execution of the CPU 101, parameters to be appropriately varied in the execution thereof, and the like.

Notebook Terminal 200

The notebook terminal 200 has a CPU 201, a ROM 202, a RAM 203, the communication I/F 204, the display control unit 205, the operation input unit 207, a communication 208, and the touch panel 250. The CPU 201, the ROM 202, the RAM 203, the operation input unit 207, the display control unit 205, and the communication I/F 208 are mutually connected by a host bus 209 formed by a CPU bus or the like. Although configurations will be described hereinafter, the description of basic functions that are substantially the same as described with regard to the text terminal 100 is omitted here.

The display control unit 205 generates image data and controls the touch panel 250 to display the generated image data. More specifically, the display control unit 205 in accordance with this embodiment controls a display of notebook data 220 (including a notebook template 440) received from the server 40.

The touch panel 250 has a display function and an operation input function, and, for example, senses a contact position (position information) of a finger, which is an operation body, by adopting an electrostatic capacitive type, as the operation input function.

The operation input unit 207 receives an operation input by the student based on information sensed by the touch panel 250. More specifically, the operation input unit 207 in accordance with this embodiment receives writing for notebook data displayed on the touch panel 250 (inputs for input components included in the notebook template 440 such as image attachment and character input) or a scoring request.

The communication I/F 204 performs wireless communication for example, communication using Wi-Fi) with the access point 50, and transmits and receives data to and from the terminal managing apparatus 30 or the server 40 via the dedicated network 20 illustrated in FIG. 1. In addition, the communication I/F 208 performs communication with the communication I/F 108 of the text terminal 100 (for example, communication using a LAN), and transmits and receives data.

The configuration of the learning terminal 10 in accordance with embodiment has been described above in detail. The configuration of the learning terminal 10 in accordance with this embodiment is not limited to the example illustrated in FIG. 5. For example, the communication I/F 108 of the text terminal 100 may be connected to the access point 50, and the notebook terminal 200 may have a configuration in which communication with an outside is performed via, the text terminal 100.

(2-3-2. Use Example)

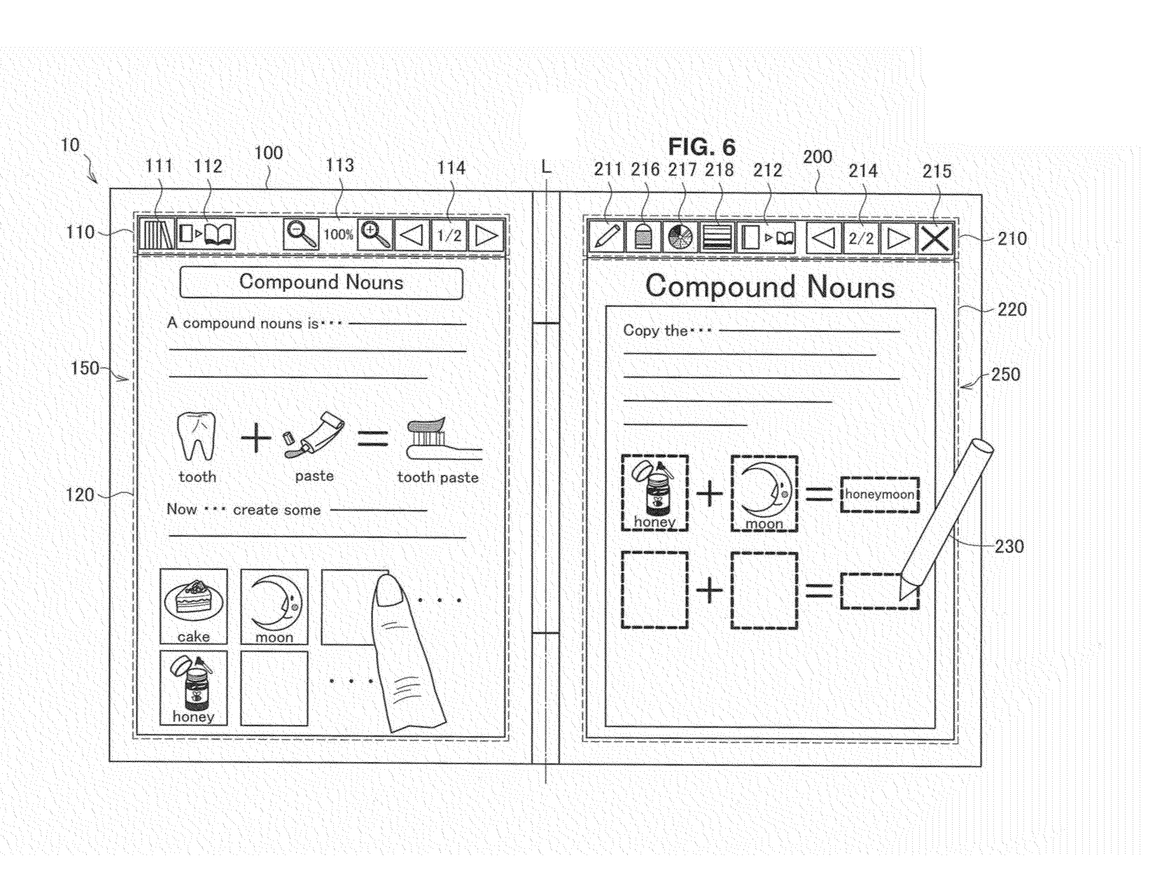

Next, the use example of the learning terminal 10 having the above-described configuration will be described with reference to FIG. 6. FIG. 6 is a diagram illustrating the use example of the learning terminal 10 in accordance with this embodiment.

Here, as illustrated in FIG. 6, the text terminal 100 and the notebook terminal 200 constituting the learning terminal 10 are connected to be opened and closed around a rotation axis L. At the point of use, as illustrated in FIG. 6, the text terminal 100 and the notebook terminal 200 are open to left and right around the rotation axis L, and are arranged such that display faces (the touch panels 150 and 250) are visible.

Teaching material data is displayed on the touch panel 150 of the text terminal 100, and a notebook template is displayed as notebook data on the touch panel 250 of the notebook terminal 200. In addition, the touch panel 250 displays data input by the student while superimposing the data with the notebook template.

The student uses the learning terminal 10 on which teaching material data or notebook data is displayed as described above and content (input data) written by the student himself/herself is displayed on the notebook data by setting the learning terminal 10 to a two-page spread state. In the example illustrated in FIG. 6, work-sheet content is displayed as an example. Hereinafter, an example of display content of the learning terminal 10 at the time of use will be described.

Touch Panel 150

As illustrated in FIG. 6, the touch panel 150 of the text terminal 100 displays teaching material data 120 such as textbook data or a workbook and a menu bar 110 displaying operation icons.

For example, as illustrated in FIG. 6, the menu bar 110 includes operation icons 111 to 114. The operation icon 111 is an icon for selecting teaching material data. The touch panel 150 can display a list of teaching material data capable of being displayed when the operation icon 111 is touched with a finger 130, and hence the student can select desired teaching material data. In the example of FIG. 6, text of work-sheet content is displayed as an example of the teaching material data.

The operation icon 112 is an icon to be operated when a bookmark function is used. When the operation icon 112 is touched with the finger 130, notebook data associated with teaching material data displayed on the touch panel 150 is displayed on the touch panel 250 of the notebook terminal 200.

The operation icon 113 is an icon for operating the enlargement/reduction of display magnification. In addition, the operation icon 114 is an icon for operating a display page of the teaching material data.

Touch Panel 250

As illustrated in FIG. 6, the touch panel 250 of the notebook terminal 200 displays a menu bar 210 displaying notebook data 220 and operation icons. In the example of FIG. 6, a notebook (answer field) of work-sheet content is displayed as an example of the notebook data 220.

For example, as illustrated in FIG. 6, the menu bar 210 includes operation icons 211 to 215. The operation icon 211 is an icon for inputting (writing) data using a pen 230. In addition, the operation icon 216 is an icon for deleting written data. In addition, the operation icon 217 is an icon for selecting a display color when there is a pen input. In addition, the operation icon 218 is an icon for selecting a thickness of a pen input line.

The operation icon 212 is an icon to be operated when a bookmark function is used. When the operation icon 212 is touched with the pen 230, teaching material data associated with notebook data displayed on the touch panel 250 is displayed on the touch panel 150 of the text terminal 100.

The operation icon 214 is an icon for operating a display page of the notebook data. In addition, the operation icon 215 is an icon for ending the display of the notebook data,

(2-3-3. Other Use Examples)

The use example of the learning terminal 10 in accordance with this embodiment is not limited to the two-page spread state around the rotation axis L as illustrated in FIG. 6. For example, the text terminal 100 and the notebook terminal 200 provided in the learning terminal 10 have an attachable/detachable connection structure, and the two may transmit and receive data to and from each other according to wireless communication (for example, Wi-Fi). In this case, the student can use the text terminal 100 and the notebook terminal 200 by placing each of the text terminal 100 and the notebook terminal 200 in an easy-to-use position or direction.

(2-3-4. Structure of Notebook Data)

Next, the notebook data 220 displayed on the touch panel 250 will be described. The notebook data 220 in accordance with this embodiment has a structure in which a plurality of layers are superimposed. The plurality of layers, for example, are three layers formed by a first layer including red-pen data input by the teacher or an automatic scoring result, a second layer including data input by the student, and a third layer including a notebook template. The notebook data 220 having the structure in which three layers are superimposed will be specifically described hereinafter.

Three Layers

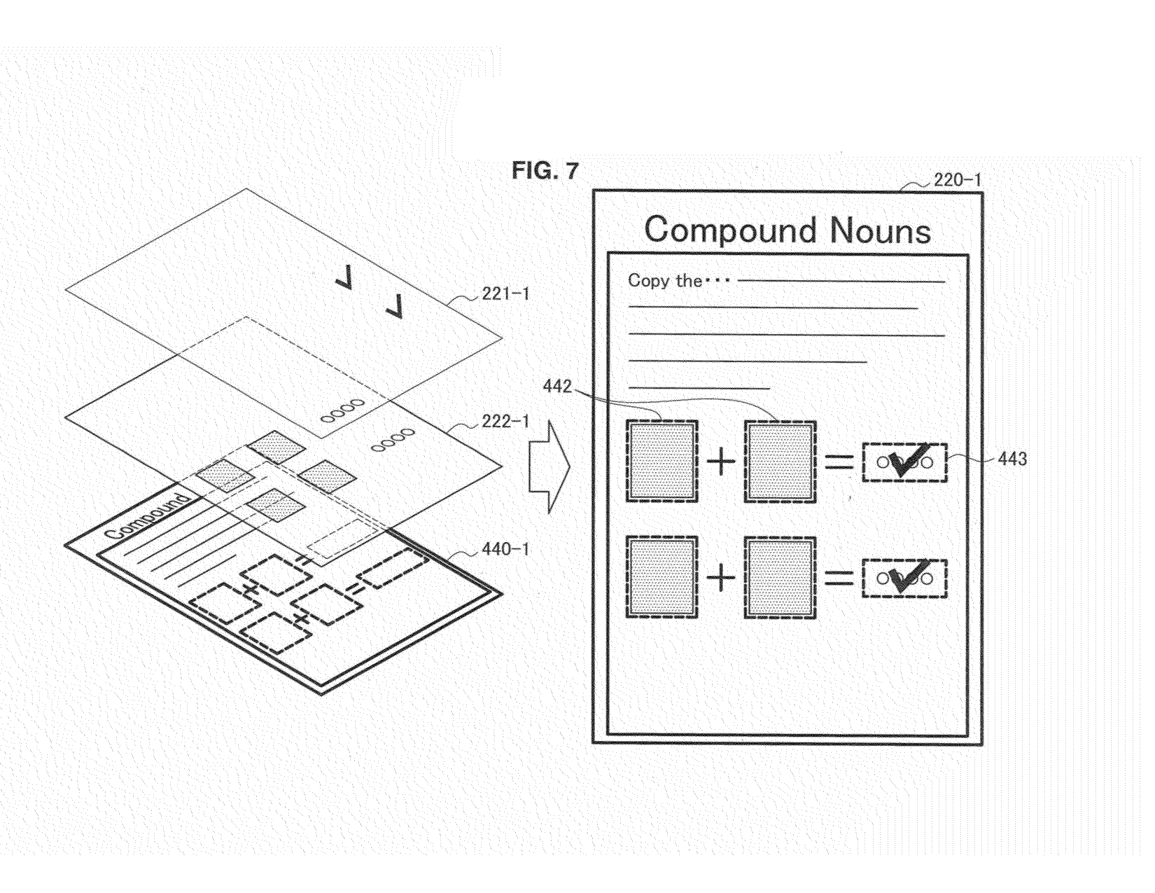

FIG. 7 is a conceptual diagram illustrating three layers included in notebook data 220-1 of work-sheet content. The display control unit 205 displays the notebook data 220-1 by superimposing a notebook template 440-1 of work-sheet content, a layer 222-1 including data input by the student, and a layer 221-1 including red-pen data input by the teacher.

In addition, different access rights are set for the three layers. For example, because the notebook template 440-1 is a base image, access right is set so that the notebook template 440-1 is not affected by editing such as a layout change or the like by the student (for example, from the learning terminal 10). Because data input by the student for the notebook template 440-1 is displayed as the layer 222-1 on the notebook template 440-1, a related data input does not infringe on the access right set in the notebook template 440-1.

In addition, the right to access the layer 222-1 is set so that only access from the learning terminal 10 used by the student is accepted. Because data by the teacher for data input by the student is displayed as the layer 221-1 including the red-pen data on the layer 222-1, an input of related red-pen data does not infringe on the access right set for the layer 221-1.

In addition, the right to access the layer 221-1 is set so that only access from the terminal managing apparatus 30 used by the teacher and the server 40 that performs automatic scoring is accepted.

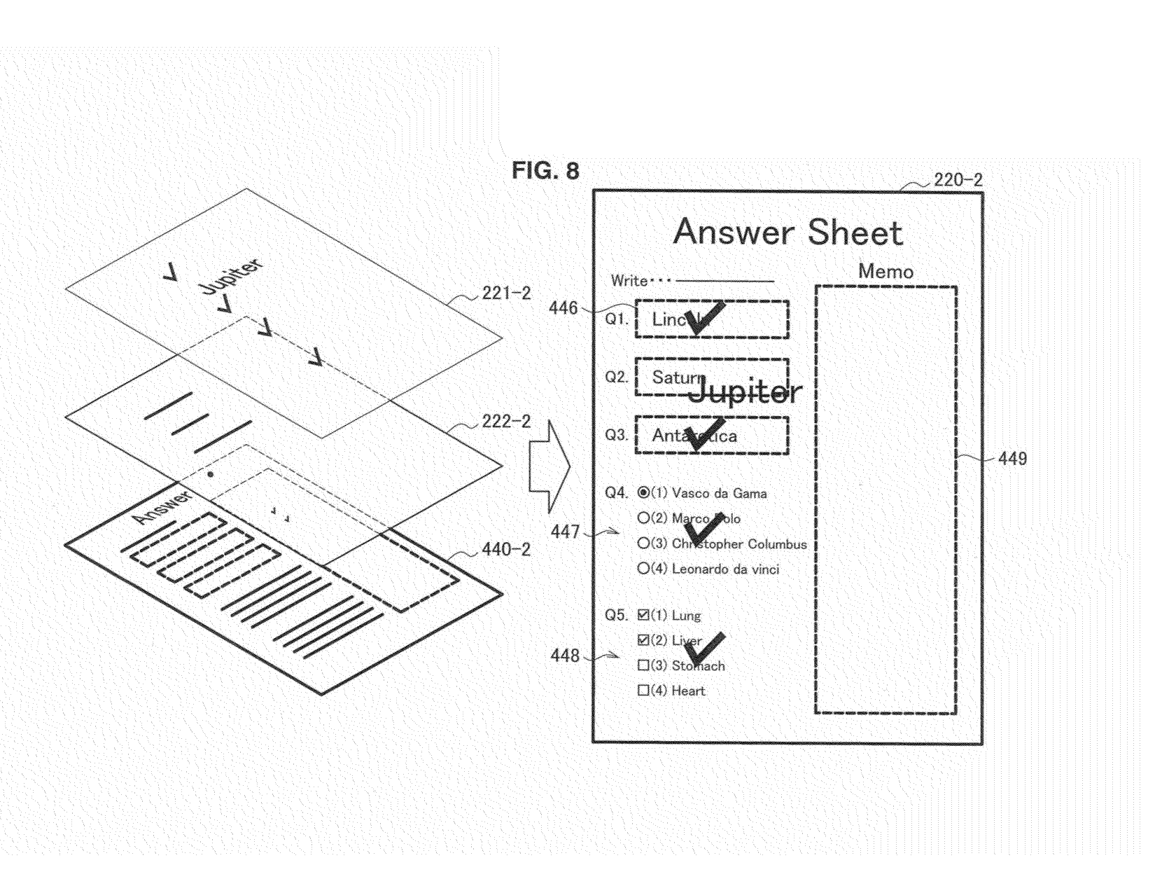

The concept of the three layers included in the notebook data 220 has been described above. The notebook data 220 in accordance with this embodiment is not limited to the notebook data 220-1 of the work-sheet content as illustrated in FIG. 7. For example, notebook data 220-2 of test content as illustrated in FIG. 8 may be provided. For the notebook data 220-2 of the test content, as illustrated in FIG. 8, a notebook template 440-2 of text content, a layer 222-2 including data input by the student, and a layer 221-2 including an automatic scoring result are superimposed. Even for these three layers, different access rights are set as described above.

Notebook Template 440

Next, the notebook template 440 included in the three layers of the notebook data 220 will be specifically described. As described above, the notebook template 440 is displayed as the base image of the notebook data in the notebook terminal 200. In addition, the notebook template 440 includes an input component for allowing the student to write (data input) in a determined format.

For example, a notebook template 440-1 of work-sheet content illustrated in FIG. 7 includes an image attachment (input) area 442 and a character recognition (text input) area 443 as input components. The student attaches (drags and flips) an item copied from text of work-sheet content (see the teaching material data 120 illustrated in FIG. 6) displayed on the text terminal 100 to the image attachment area 442. In addition, when the student inputs a handwritten character to the character recognition area 443 with the pen 230, recognized character data is displayed in the character recognition area 443.

In addition, for example, the notebook template 440-2 of test content illustrated in FIG. 8 includes a character recognition area 446 (text box), a radio button 447, a check box 448, and a memo input area 449 as input components. The memo input area 449 receives data handwritten and input by the student with the pen 230 as image data.

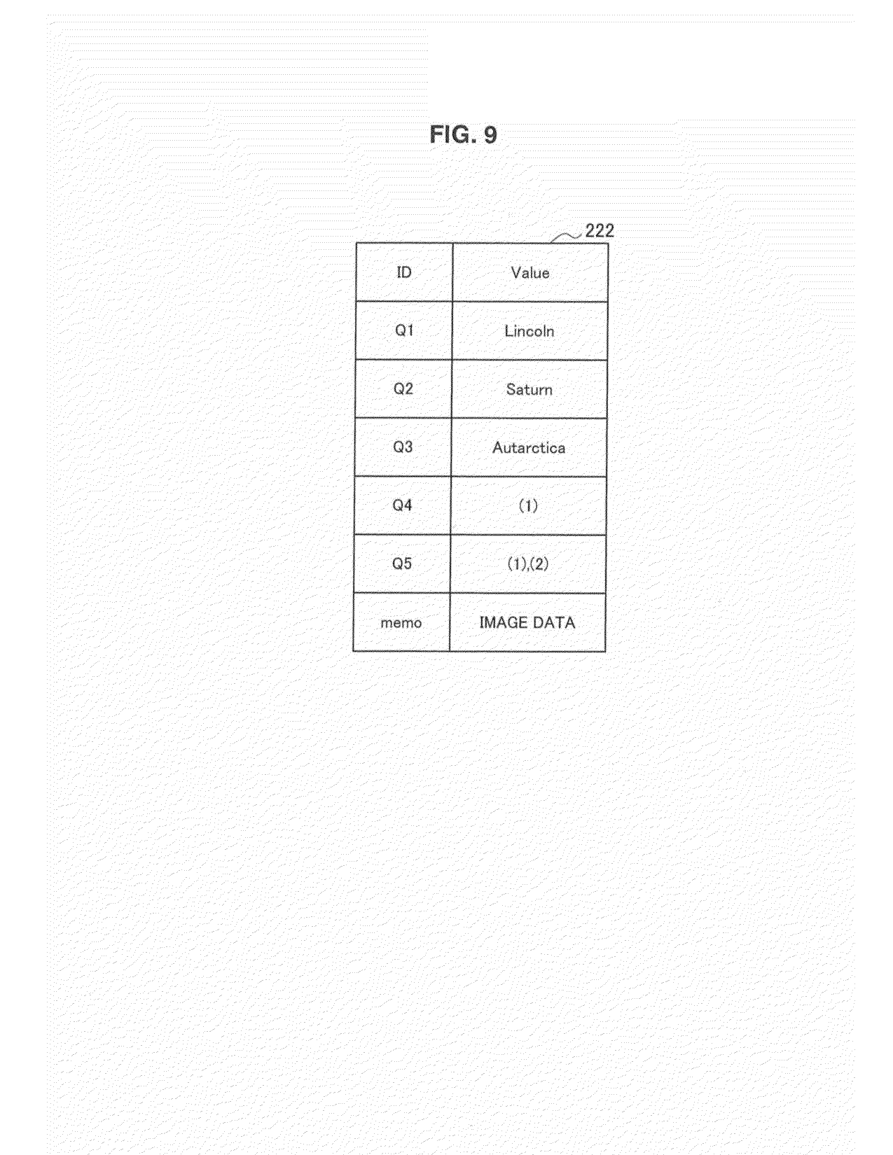

As described above, when the notebook template 440 is displayed as the base image differently from when the student writes freely; data is input in a determined format. For example, data input by the student for the template 440-2 illustrated in FIG. 8 has a data structure as illustrated in FIG. 9.

FIG. 9 is a diagram illustrating data in which, for example, a character string, a numerical value, and the like, are input, in a format in which automatic scoring is easy, based on each input component of the notebook template 440-2. The server 40 can receive input data of the same format as in a data structure illustrated in FIG. 9 from each learning terminal 10 and perform automatic scoring.

Here, the notebook template 440 displayed on the notebook terminal 200 is pre-associated with a page of the teaching material data 120 displayed on the text terminal 100. The associations between pages of the teaching material data 120 and notebook templates 440 are performed by a teacher or content creator, and stored as link information 450 in the content storage unit 403 of the server 40 as illustrated in FIG. 4.

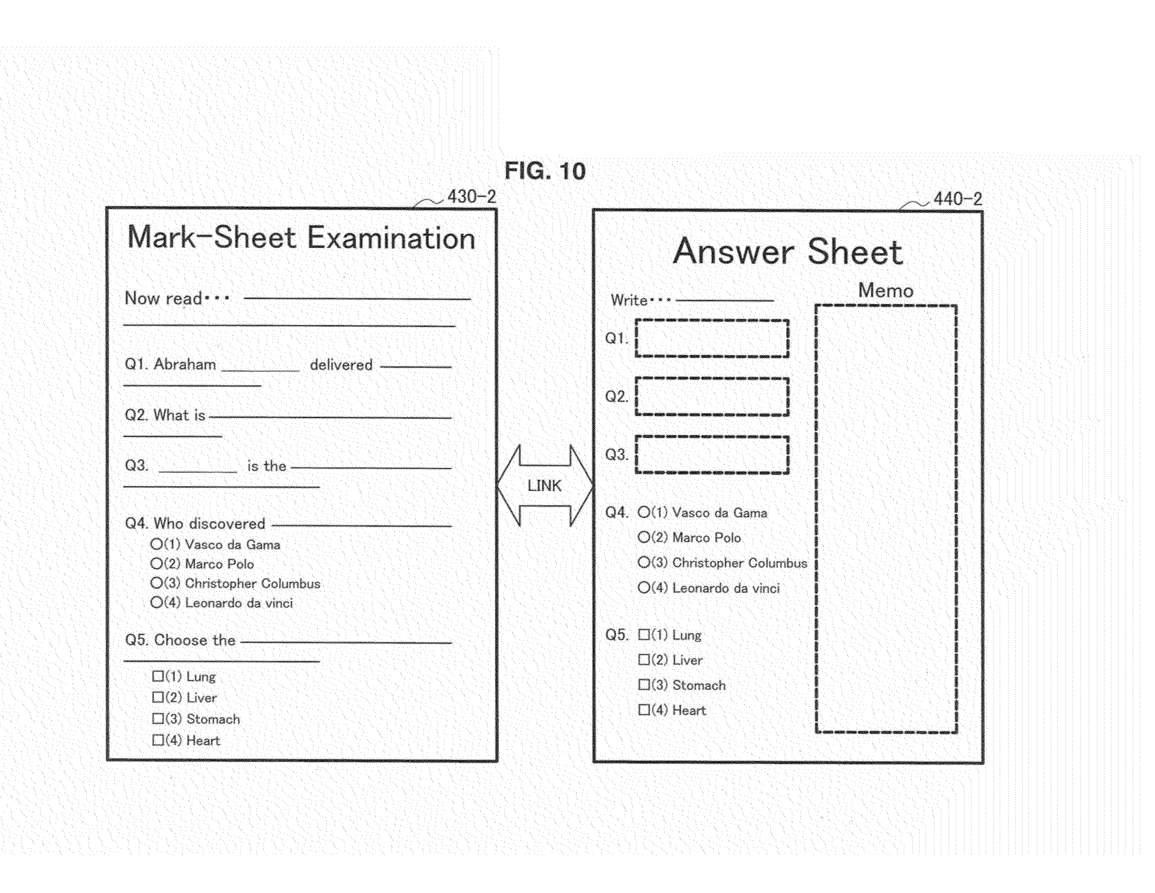

For example, the notebook template 440-2 of the test content described with reference to FIG. 8 is associated with test question data 430-2 of test content as illustrated in FIG. 10. In this case, the test question data 430-2 is displayed on the touch panel 150 in the text terminal 100 of the learning terminal 10, and the notebook template 440-2 is displayed on the touch panel 250 in the notebook terminal 200. The associations between the pages of the teaching material data 120 and the notebook templates 440 will be described in detail in [3-1. Notebook Template Selection].

### 3. OPERATION PROCESSING

The basic configuration of each apparatus included in the learning system in accordance with the embodiment of the present disclosure has been described above. Next, the operation processing of the learning system in accordance with this embodiment will be described.

[3-1. Notebook Template Selection]

As described above, the notebook templates 440 are pre-associated with the pages of the teaching material data 430, and the link information 450 indicating the association is stored in the content storage unit 403 of the server 40. In addition, the association is set by the teacher or the learning content creator.

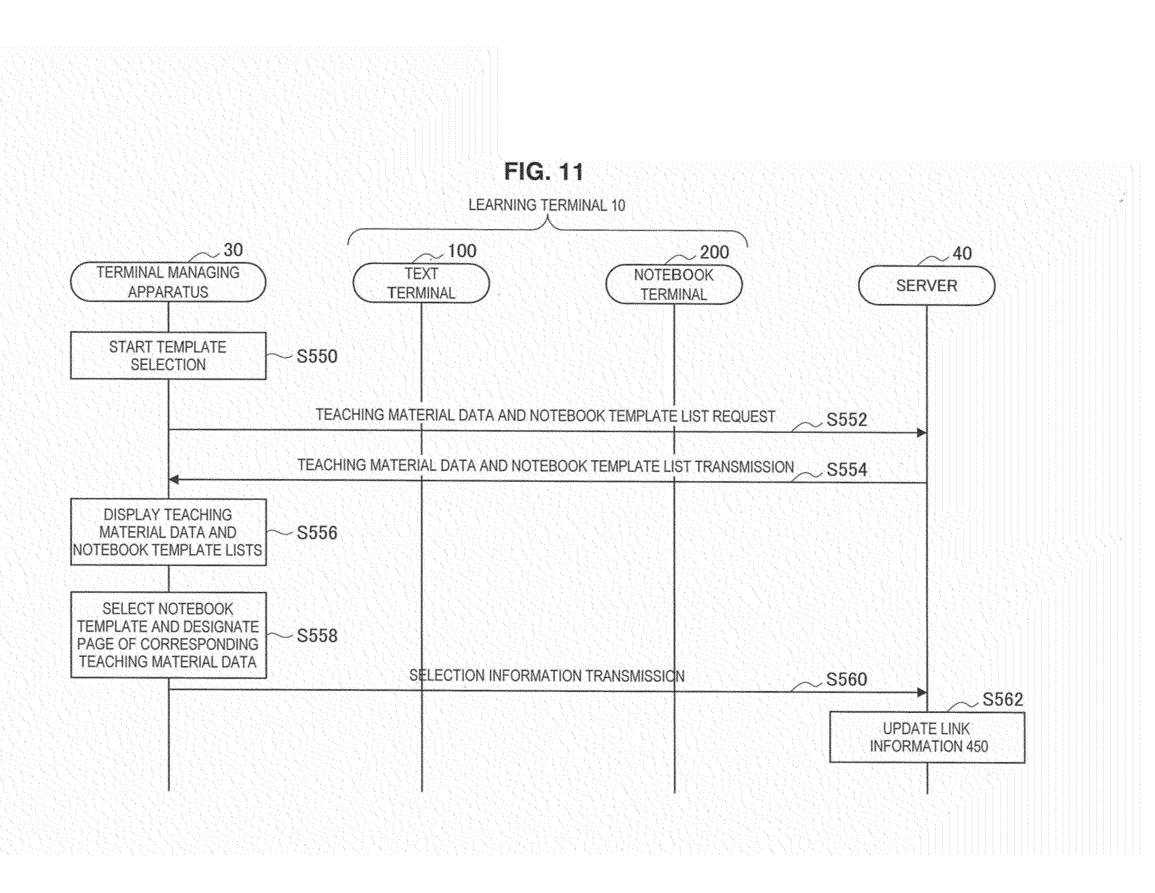

When creating the teaching material data 430 and the notebook template 440, the learning content creator may set the association of the two. In addition, before the teacher teaches the lesson, the association of the two may be set by selecting a predetermined notebook template from a plurality of notebook templates 440 according to a proficiency level or characteristics of the student and designating a page of corresponding (associated) teaching material data. Hereinafter, the selection of the notebook template by the teacher will be specifically described with reference to FIGS. 11 to 13.

FIG. 11 is a sequence diagram illustrating operation processing when the teacher selects the notebook template 440 associated with the teaching material data 430 from the terminal managing apparatus 30. As illustrated in FIG. 11, first, in step S550, the terminal managing apparatus 30 detects a template selection start operation.

Then, in step S552, the terminal managing apparatus 30 sends a teaching material data page list request and a notebook template list request from the communication I/F 304 to the server 40.

Next, in step S554, the server 40 extracts a page list of teaching material data and a list of a plurality of notebook templates capable of corresponding to the teaching material data from the teaching material DB 43 of the content storage unit 403, and transmits the lists to the terminal managing apparatus 30. The lists may be thumbnail images or text obtained by summarizing pages. In addition, the server 40 may transmit content data (the teaching material data 430 and the notebook templates 440) along with the lists.

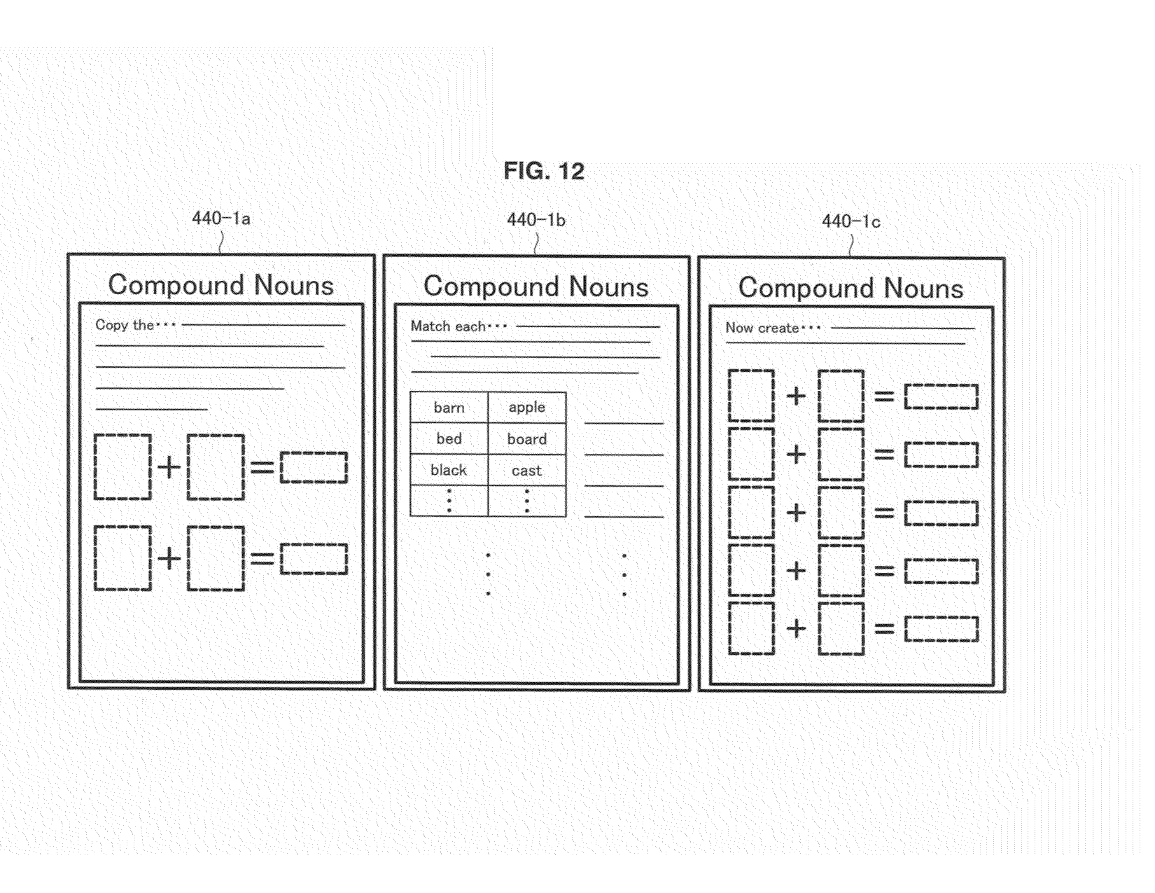

Then, in step S556, the terminal managing apparatus 30 displays the page list of teaching material data and the list of the plurality of notebook templates capable of corresponding to the teaching material data. Here, an example of the plurality of notebook templates is illustrated in FIG. 12.

Notebook templates 440-1a, 440-1b, and 440-1c illustrated in FIG. 12 are a plurality of notebook templates capable of corresponding to text of work-sheet content illustrated as an example of the teaching material data 120 in FIG. 6.

As illustrated in FIG. 12, the notebook template 440-1a is a template that is easily understood by the student and suitable for introduction because the number of questions is small and great use of illustrations is made. The notebook template 440-1b is a template suitable for the student to increase his or her understanding because the number of questions is large but the number of hints is also large. The notebook template 440-1c is a template suitable to measure the ability of the student because the number of questions is large and the number of hints is small.

As described above, for example, the teacher can select an optimum notebook template according to a proficiency level or characteristics of the student because an answer field (base image) of work-sheet content is not pre-fixed and a plurality of types of corresponding notebook templates are prepared for each text page.

Next, in step S558, the terminal managing apparatus 30 receives a notebook template selection operation and an operation of designating a corresponding teaching material data (text) page by the teacher. Further, the terminal managing apparatus 30 may receive a notebook template editing operation by the teacher.

Then, in step S560, the terminal managing apparatus 30 transmits selection information (selected template information and teaching material data page designation information) to the server 40 so that a selected template is associated with a designated page of teaching material data. In addition, when the selected notebook template has been edited, the terminal managing apparatus 30 transmits the selection information to the server 40 along with the edited notebook template.

Next, in step S562, the server 40 updates the link information 450 stored in the teaching material DB 43 of the content storage unit 403 based on the selection information transmitted from the terminal managing apparatus 30. In addition, when the edited notebook template from the terminal managing apparatus 30 has been transmitted, the server 40 stores the edited notebook template in the teaching material DB 43 of the content storage unit 403.

According to the above, the teacher can easily customize learning content by selecting/editing a notebook template 440 desired to be used in the lesson from a plurality of pre-created notebook templates 440 in advance before the lesson. In addition, the teaching material data 430 and the notebook template 440 associated as described above are displayed on the learning terminal 10 to be used by the student. A display control process in the learning terminal 10 will be described in detail in [3-2, Lesson Start Process].

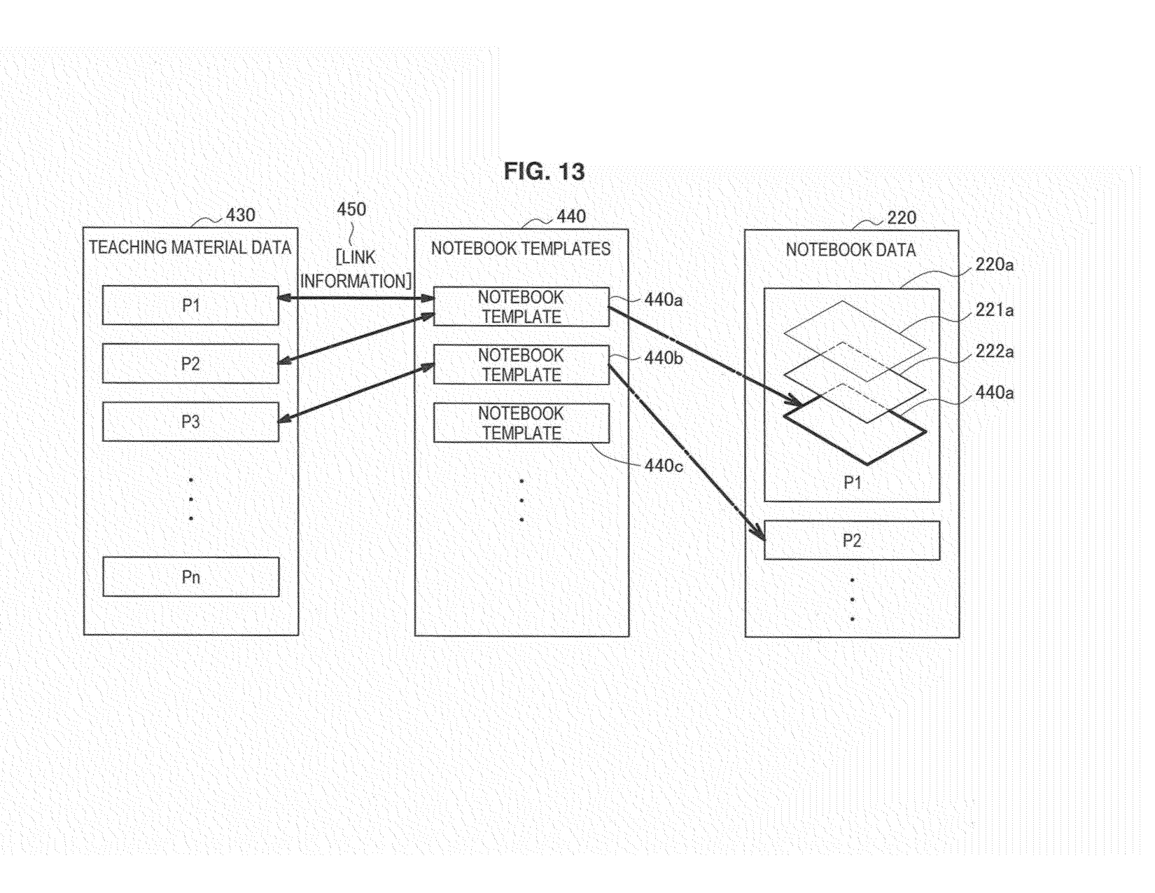

Here, a relationship among the teaching material data 430 and the notebook template 440 stored in the content storage unit 403 and the notebook data 220 displayed on the notebook terminal 200 of the learning terminal 10 will be described with reference to FIG. 13.

Relationship Between Data

FIG. 13 is a conceptual diagram illustrating a relationship among the teaching material data 430, the notebook template 440, and the notebook data 220. As illustrated in FIG. 13, each page of the teaching material data 430 is pre-associated with a notebook template among the notebook templates 440 by the teacher, and the association is indicated by the link information 450. In the example illustrated in FIG. 13, a notebook template 440a is associated with first and second pages of the teaching material data 430. In addition, a notebook template 440b is associated with a third page of the teaching material data 430.

In addition, notebook data 220 displayed on the notebook terminal 200 of the learning terminal 10 has a structure in which three layers are superimposed and displayed as described above. Consequently, when the first page of the teaching material data 430 has been displayed on the text terminal 100 of the learning terminal 10, a first page 220a of the notebook data 220 displays the notebook template 440a as a base image as illustrated in FIG. 13.

Further, the first page 220a of the notebook data 220 may include a layer 222a formed by input data from the student and a layer 221a formed by correction data (red-pen data or scoring result data). The notebook data 220 illustrated in FIG. 13 is stored for every student in the content storage unit 403 of the server 40.

The selection of a notebook template associated with each page of the teaching material data 430 has been described above in detail. It is also possible to consider the case in which the terminal managing apparatus 30 is installed as an apparatus (teacher console) integrated with the teacher's desk in a classroom. In this case, a process of selecting the above-described notebook template to be performed in advance before the lesson may be performed using a teacher console type terminal managing apparatus 30 or an information processing apparatus type terminal managing apparatus 30 placed in a teachers' room or the like.

[3-2. Lesson Start Process]

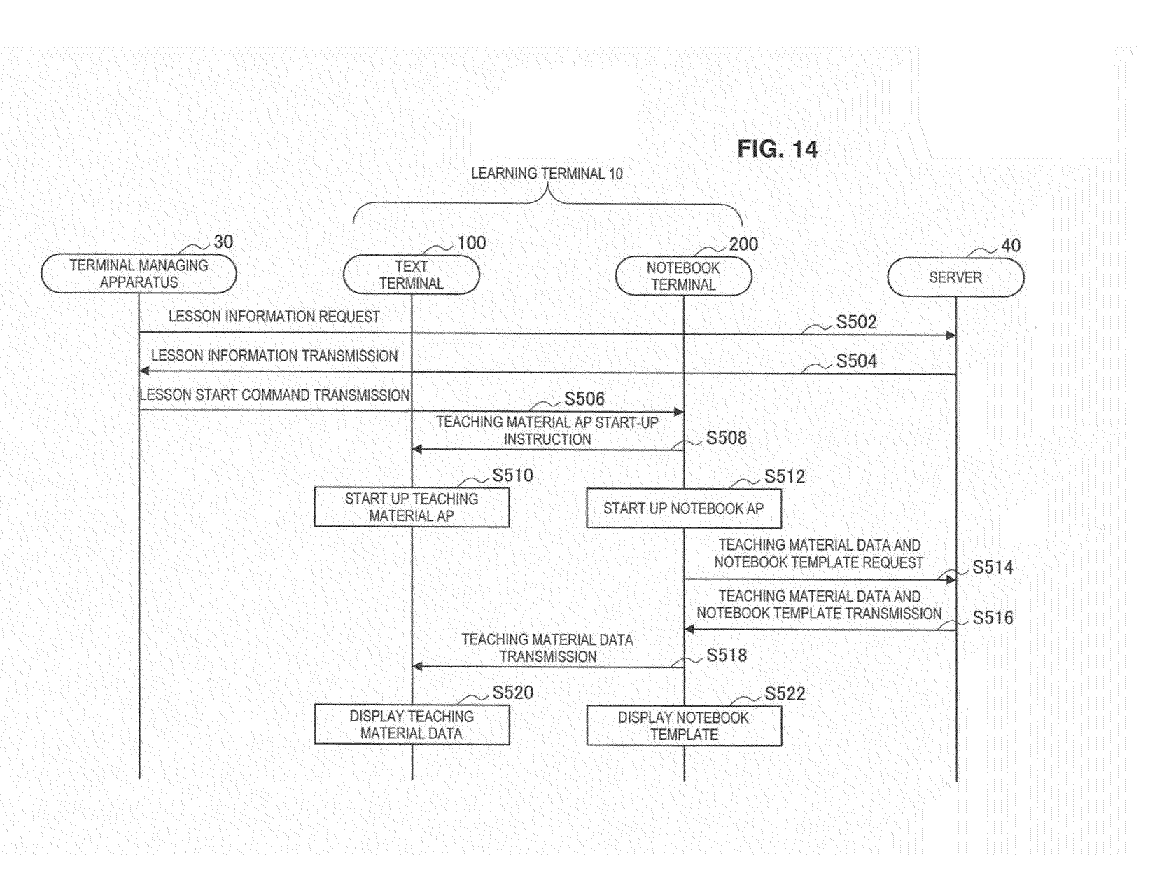

Next, operation processing of the learning system in accordance with this embodiment when the teacher starts the lesson will be described with reference to FIG. 14. FIG. 14 is a sequence diagram illustrating the lesson start process in accordance with this embodiment.

As illustrated in FIG. 14, first, in step S502, the terminal managing apparatus 30 requests the server 40 to transmit lesson information including data necessary for the progress of a lesson such as curriculum data, a student roll, a subject list, and teaching material data.

Then, in step S504, the server 40 extracts the lesson information from each DB of the content storage unit 403 according to the request from the terminal managing apparatus 30, and transmits the extracted lesson information to the terminal managing apparatus 30 of a request source.

Next, in step S506, the terminal managing apparatus 30 transmits a lesson start command to the notebook terminal 200 of the learning terminal 10. The lesson start command includes information for specifying teaching material data displayed on the text terminal 100 of the learning terminal 10 such as a subject, a teaching material name, and a specified page.

Then, in step S508, the notebook terminal 200 instructs the text terminal 100 to start up a teaching material application (AP). Next, in step S510, the text terminal 100 starts up the teaching material AP.

On the other hand, in step S512, the notebook terminal 200 starts up a notebook AP. Then, in step S514, the notebook terminal 200 requests the server 40 to transmit the teaching material data and the notebook template based on the information for specifying the teaching material data included in the lesson start command.

Next, in step S516, the server 40 extracts teaching material data 430 corresponding to the request from the teaching material DB 43 of the content storage unit 403. In addition, the server 40 extracts a notebook template 440 associated with the teaching material data 430 extracted according to the request based on the link information 450. The server 40 transmits the extracted teaching material data 430 and the notebook template 440 to the notebook terminal 200.

Then, in step S518, the notebook terminal 200 transmits the teaching material data transmitted from the server 40 to the text terminal 100.

Next, in step S520, the text terminal 100 displays the teaching material data on the touch panel 150.

On the other hand, in step S522, the notebook terminal 200 displays the notebook template on the touch panel 250.

According to the above, in the learning system in accordance with this embodiment, the teacher designates a predetermined page of predetermined teaching materials at the initiation of a lesson in the terminal managing apparatus 30, and the predetermined page of the predetermined teaching materials can be caused to be displayed on the learning terminal 10 to be used by each student.

Further, in the learning system in accordance with this embodiment, the predetermined page of the predetermined teaching materials can be caused to be displayed on the learning terminal 10 to be used by each student because the notebook template is pre-associated with each page of the teaching material data.

As described above, the teacher can efficiently start the lesson because it is possible to manage the learning terminal 10 of each student using the terminal managing apparatus 30.

[3-3. Red-Pen Input Process (Correction Process)]

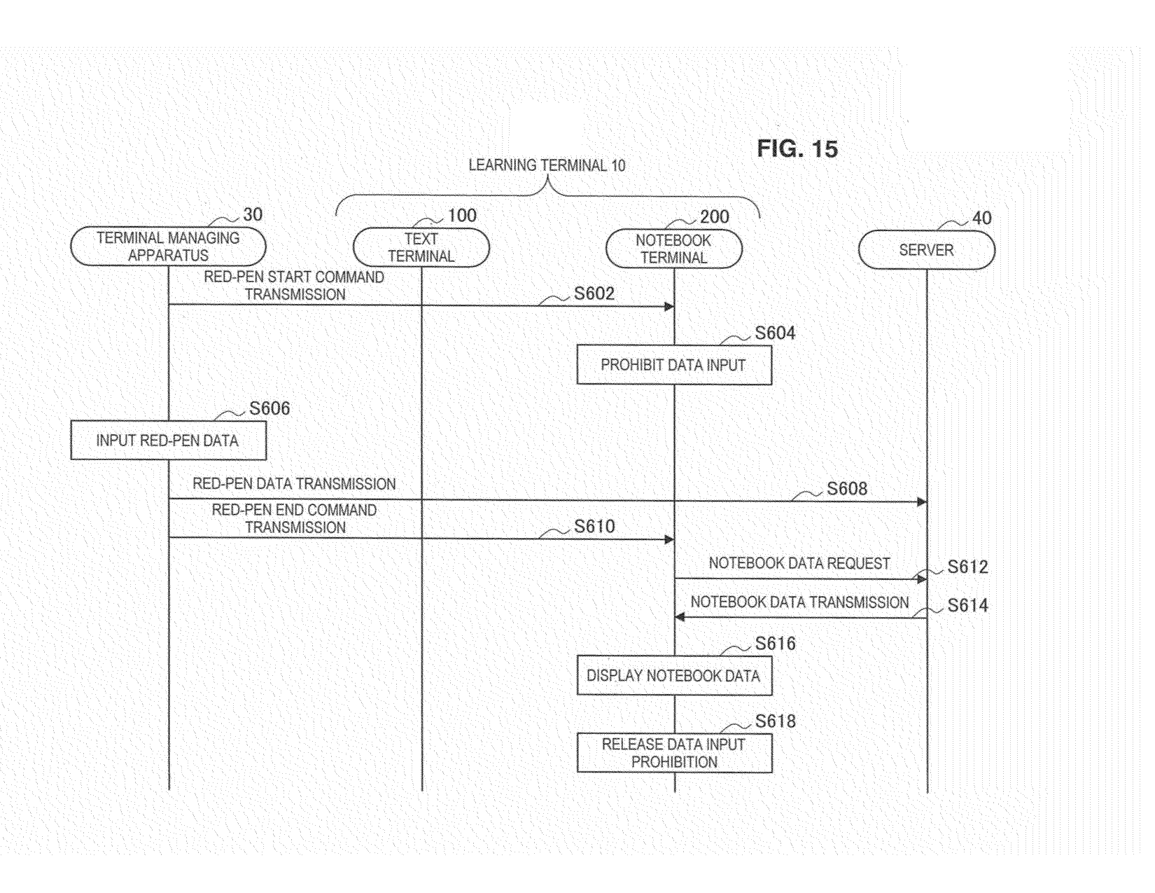

Next, operation processing of the learning system in accordance with this embodiment when the teacher performs a correction (red-pen input) operation on data input by each student, for example, to a notebook template of work-sheet content will be described with reference to FIG. 15. FIG. 15 is a sequence diagram illustrating the red-pen input process in accordance with this embodiment.

As illustrated in FIG. 15, first, in step S602, the terminal managing apparatus 30 transmits a red-pen start command to the notebook terminal 200 of the learning terminal 10. Then, in step S604, the notebook terminal 200 prohibits a data input by the student.

Next, in step S606, the terminal managing apparatus 30 receives red-pen data for the student input data. Here, the terminal managing apparatus 30 may display a list of notebook data 220 displayed on the learning terminal 10 of each student and notebook data selected from the list on the display apparatus 310. The teacher can read the notebook data 220 of the student displayed on the display apparatus 310, and separately or collectively input red-pen data for the notebook data 220 of the students from the operation input unit 320.

Then, in step S608, the terminal managing apparatus 30 transmits the input red-pen data to the server 40. The server 40 updates the notebook data 220 of each student stored in the student terminal DB 42 of the content storage unit 403 based on the received red-pen data.

Next, in step S610, the terminal managing apparatus 30 transmits a red-pen end command to the notebook terminal 200 of the learning terminal 10.

Then, in step S612, the notebook terminal 200 requests the server 40 to transmit notebook data. Next, in step S614, the server 40 extracts the notebook data 220 to which red-pen data has been added for the student using the learning terminal 10 of a request source from the student terminal DB 42, and transmits the extracted notebook data to the notebook terminal 200.

Then, in step S616, the notebook terminal 200 displays the notebook data received from the server 40 on the touch panel 250. Next, in step S618, the notebook terminal 200 releases the data input prohibition.

According to the above, because correction content is automatically reflected in the learning terminal 10 of each student when the teacher has corrected the notebook data 220 of each student on the terminal managing apparatus 30, the lesson can more efficiently progress.

[3-4. Automatic Scoring Process]

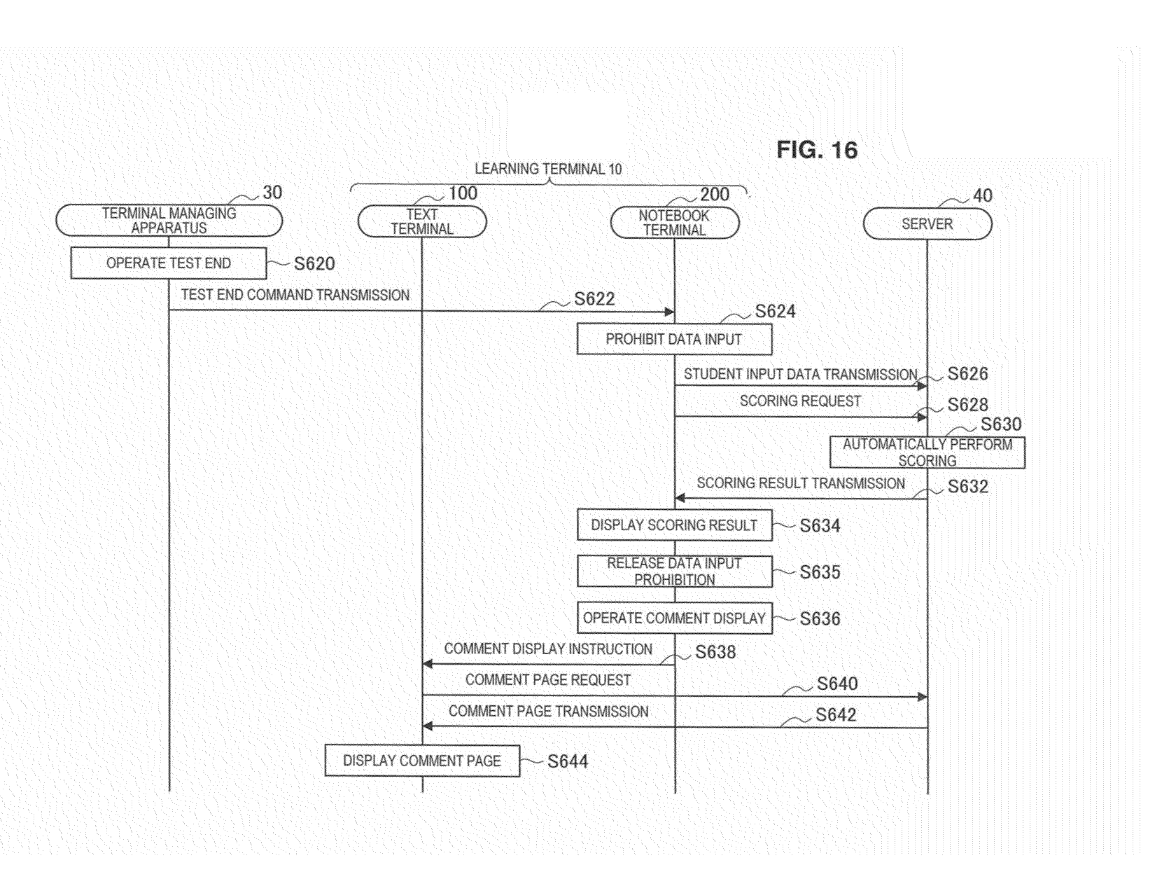

Next, operation processing of the learning system in accordance with this embodiment, for example, when the server 40 performs automatic scoring on data input by each student to a test content notebook template, will be described with reference to FIG. 16. FIG. 16 is a sequence diagram illustrating the automatic scoring process in accordance with this embodiment.

As illustrated in FIG. 16, first, in step S620, the terminal managing apparatus 30 receives a test end operation by the teacher. Next, in step S622, the terminal managing apparatus 30 transmits a test end command to the notebook terminal 200 of the learning terminal 10.

Then, in step S624, the notebook terminal 200 prohibits a data input by the student.

Next, in step S626, the notebook terminal 200 transmits the data input by the student to the server 40. Here, the data transmitted by the notebook terminal 200 to the server 40 is data input in a predetermined format in which automatic scoring is easy as described with reference to FIGS. 8 and 9. In addition, in step S628, the notebook terminal 200 sends a scoring request to the server 40.

Then, in step S630, the scoring unit 405 (see FIG. 3) of the server 40 compares the student input data (test answer) transmitted from the notebook terminal 200 with the test correct answer data 460 stored in the teaching material DB 43 of the content storage unit 403 and performs scoring.

For example, the scoring unit 405 may calculate the number of right answers or the number of points based on a predetermined rule after determining whether the student input data is right or wrong, or generate a scoring image (a check mark, a correct answer image, or the like) corresponding to a right or wrong answer. In addition, the server 40 updates the notebook data 220 of each student stored in the student terminal DB 42 of the content storage unit 403 based on the student input data transmitted from the notebook terminal 200 and the scoring result by the scoring unit 405.

Next, in step S632, the terminal managing apparatus 30 transmits the scoring result by the scoring unit 405 to the notebook terminal 200.

Then, in step S634, the terminal managing apparatus 30 displays the scoring result on the notebook terminal 200 of the learning terminal 10. Specifically, the layer 221-2 including the scoring result may be superimposed on another layer and displayed as illustrated in FIG. 8. In step S635, the notebook terminal 200 releases the data input prohibition.

Further, the learning system in accordance with this embodiment can load a comment page associated with correct answer data. When the notebook terminal 200 receives a comment display (comment load) operation by the student as illustrated in step S636 of FIG. 16, the notebook terminal 200 subsequently sends a comment display instruction to the text terminal 100 in step S638.

The comment display operation shown in the above-described step S636, for example, is an operation of tapping a scoring result itself of each question (a check mark or correct answer data included in the layer 221-2 of FIG. 8) or an operation of tapping a comment display button (not illustrated) on the side of each question.

Then, in step S640, the text terminal 100 requests the server to transmit data of a comment page. Next, in step S642, the server 40 extracts the data of the comment page corresponding to the request from the teaching material DB 43, and transmits the extracted data to the text terminal 100.

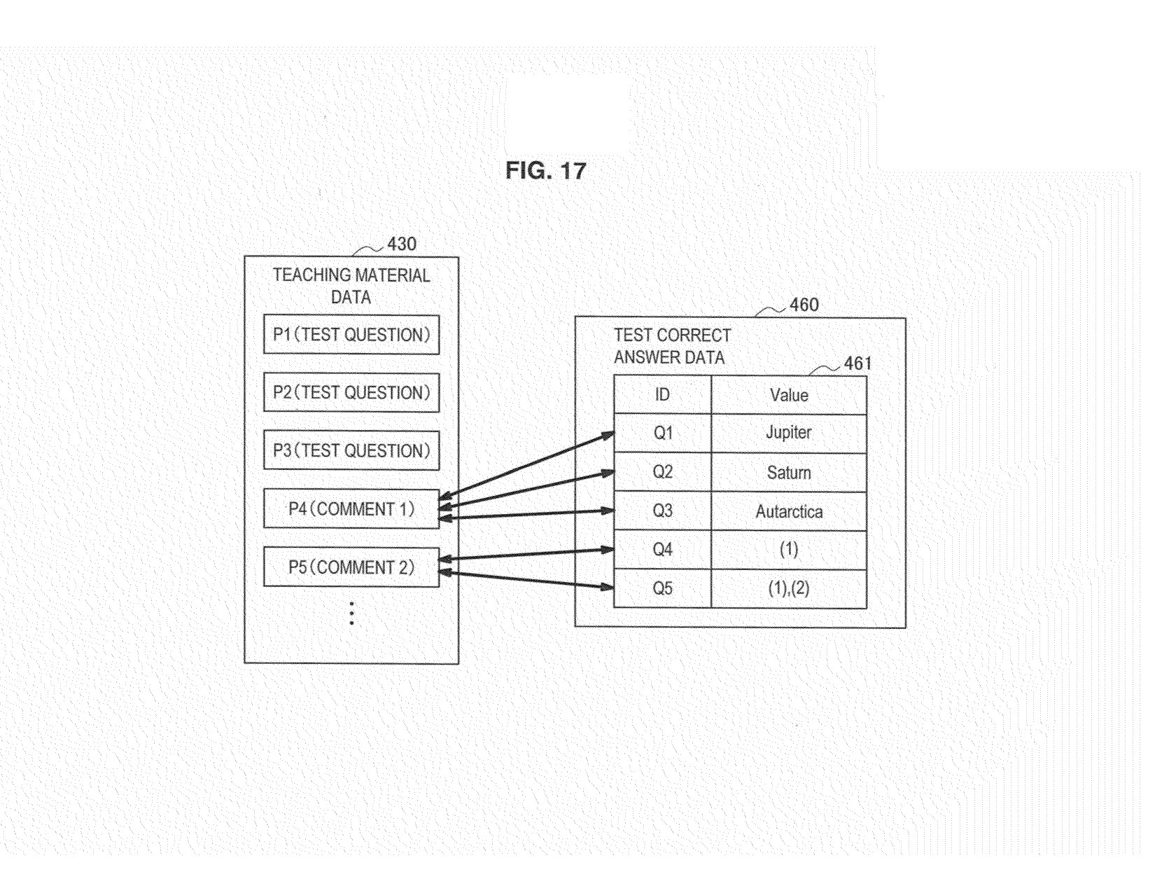

Here, the relationship between the comment page and the test correct answer data 460 will be described with reference to FIG. 17. FIG. 17 is a conceptual diagram illustrating a correspondence relationship between comment page of a test question included in the teaching material data 430 and the test correct answer data 460. As illustrated in FIG. 17, data of the comment page is included as the teaching material data 430 to be subsequent to the test question page. Each comment page corresponds to each question of the test correct answer data 460 stored in the teaching material DB 43.

Consequently, the server 40 can extract data of a comment page corresponding to a question on which the student has performed the comment display operation from the teaching material DB 43 for a comment page request from the text terminal 100. In the example illustrated in FIG. 17, for example, when the comment display operation has been performed on any one of Q1 to Q3, the server 40 extracts a fourth page (comment 1) of the teaching material data 430. In addition, for example, when the comment display operation has been performed on any one of Q4 and Q5, the server 40 extracts a fifth page (comment 2) of the teaching material data 430.

Then, in step S644, the text terminal 100 displays data of the comment page received from the server 40 on the touch panel 150.

As described above, in the learning system in accordance with this embodiment, it is possible to allow the student to input data in a predetermined format in which automatic scoring is easy and enable the server 40 to perform automatic scoring by displaying the notebook template 440. Thereby, test scoring is efficiently performed.

In addition, the scoring result by the server 40 is transmitted to the learning terminal 10, superimposed on the notebook template 440 and the data input by the student and displayed. Further, as described above, the student can refer to a comment page of a misunderstood question because the comment page of each question can be loaded in the learning terminal 10.

### 4. SWITCHING OF NOTEBOOK TEMPLATE

The case in which the notebook template 440 is displayed on the notebook terminal 200 of the learning terminal 10 and the student inputs data in the learning system in accordance with the embodiment described above has been described. However, in the learning system in accordance with this embodiment, a terminal apparatus to be used by the student is not limited to the learning terminal 10, and may be, for example, a notebook PC, a desktop PC, a smart phone, a tablet terminal, or the like.

Thereby; the student can access the server 40 and perform learning, for example, using various types of terminal apparatuses according to a place or situation such as using the learning terminal 10 in a classroom, a PC in a home, and a smart phone in an outer location.

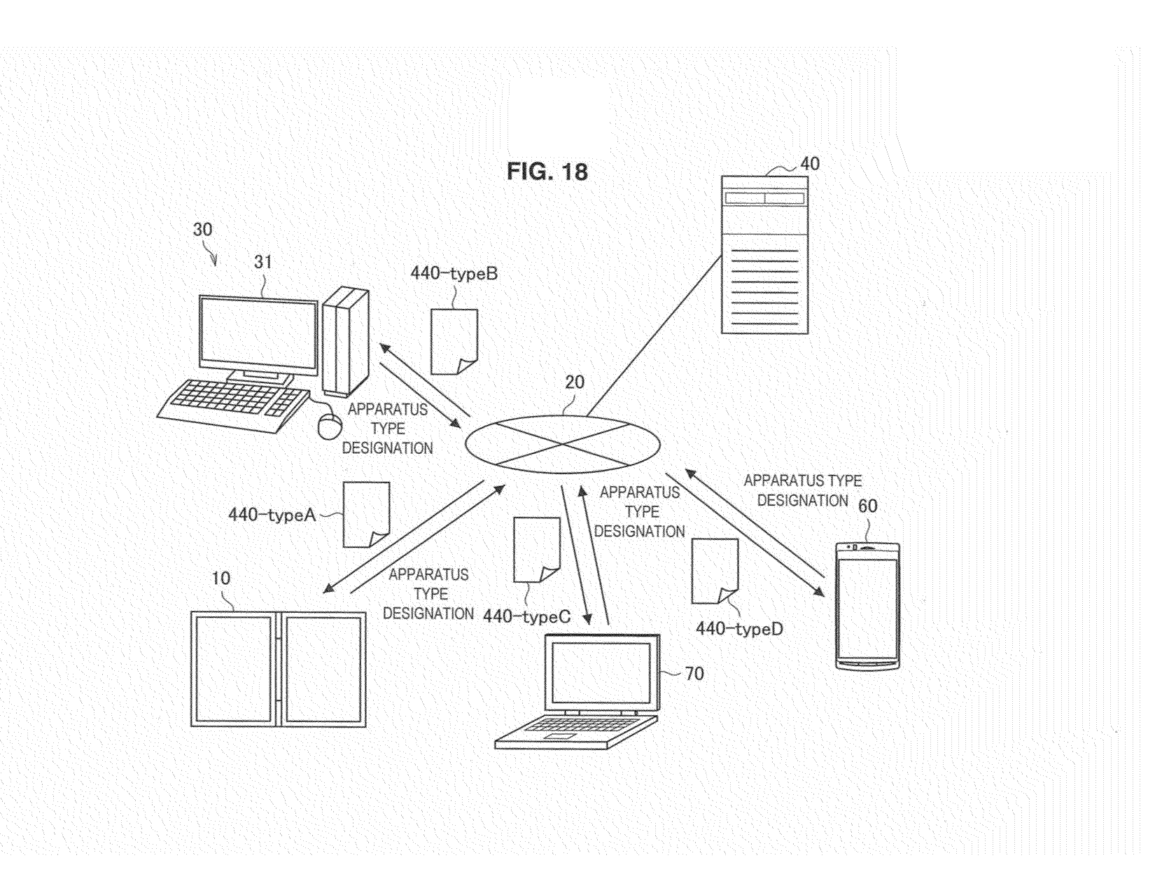

In this case, because characteristics of each display apparatus differ according to each terminal apparatus, the server 40 may transmit a notebook template 440 suitable for each terminal apparatus according to each type of terminal apparatus. Hereinafter, switching of the notebook template 440 corresponding to a type of terminal apparatus will be specifically described with reference to FIGS. 18 to 20.

[4-1. Overview]

FIG. 18 is a diagram illustrating an entire configuration of the learning system in accordance with this embodiment in which a notebook template 440 can be switched according to a type of terminal apparatus. As illustrated in FIG. 18, the configuration of the learning system in accordance with this embodiment has a smart phone 60 and a notebook PC 70 in addition to the learning system illustrated in FIG. 1. The smart phone 60 and the notebook PC 70 are connectable to the server 40 or the terminal managing apparatus 30 via the dedicated network 20. When the smart phone 60 or the notebook PC 70 is located outside school such as a home or an outer location, the smart phone 60 or the notebook PC 70 may be connected to the dedicated network 20 via an external network (not illustrated).

In the learning system in accordance with this embodiment having the above-described configuration, as illustrated in FIG. 18, each of the terminal apparatuses (the learning terminal 10, the terminal managing apparatus 30, the smart phone 60, and the notebook PC 70) reports its own apparatus type when sending a notebook template request to the server 40.

Here, for its own apparatus type designated in the server 40, more specifically, for example, a model type and detailed information (the number of vertical and horizontal pixels and dots per inch (DPI)) of a display screen are included.

The server 40 transmits notebook templates 440-type-A to 440-D corresponding to reported apparatus types to the terminal apparatuses.

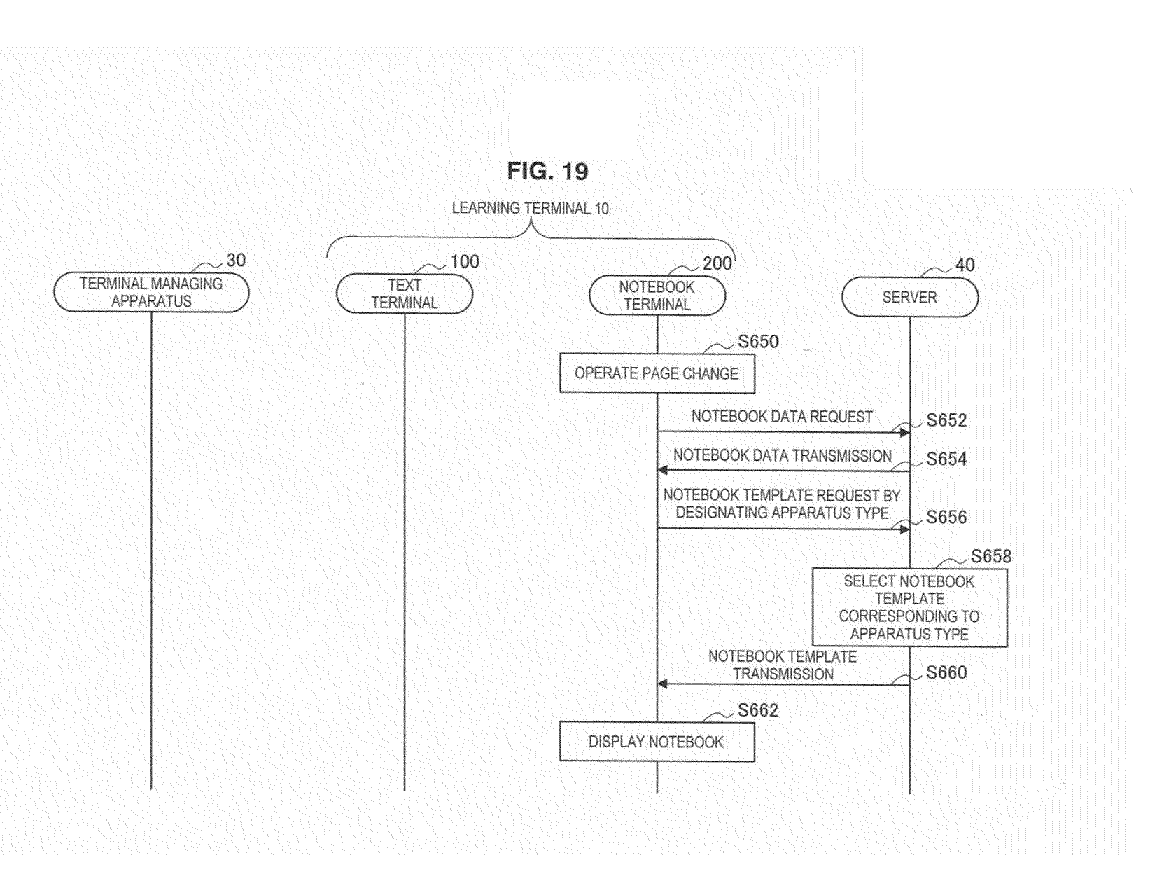

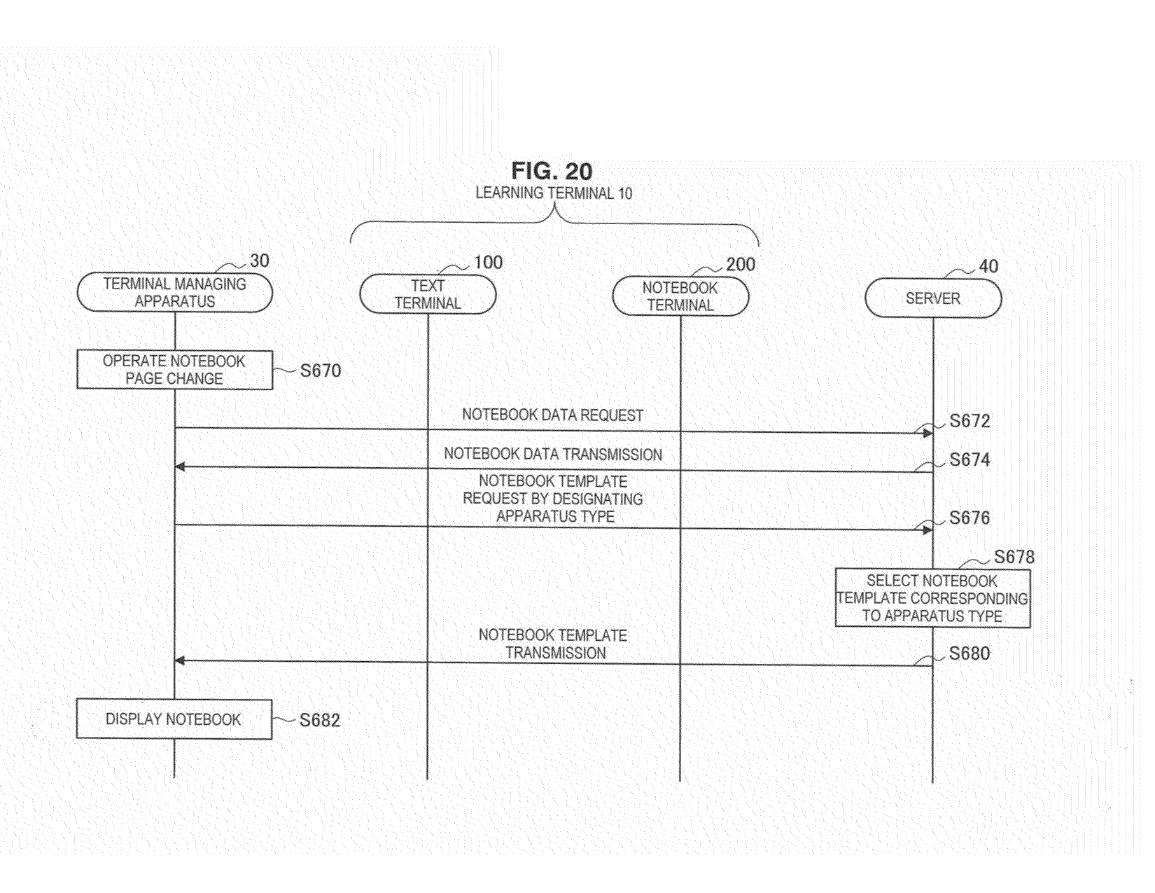

As described above, the learning system in accordance with this embodiment can display the notebook template 440 in a format suitable for each terminal apparatus. Hereinafter, operation processing of this embodiment will be described with reference to FIGS. 19 and 20,

[4-2. Request from Learning Terminal 10]

FIG. 19 is a sequence diagram illustrating operation processing when a notebook template request has been received from the learning terminal 10. Here, the notebook template request can also be performed when the student has performed a notebook page change operation in addition to a notebook template request (see step S514 of FIG. 14) at the initiation of a lesson as described in the above-described [3-3. Red-Pen Input Process]. Here, in FIG. 19, an example of the notebook template request generated as a trigger when the student has performed the notebook page change operation is included.

As illustrated in FIG. 19, in step S650, the notebook terminal 200 of the learning terminal 10 detects the notebook page change operation.

Next, in step S652, the notebook terminal 200 generates a request so that the notebook data 220 is transmitted from the communication 204 to the server 40. Then, in step S654, the server 40 extracts the notebook data 220 from the student terminal DB 42 of the content storage unit 403, and transmits the extracted notebook data 220 to the notebook terminal 200.

Here, as described above, the notebook data 220 displayed by the learning terminal 10 is a structure in which a layer of a notebook template serving as a base image, a layer including data input by the student, a layer including red-pen data input by the teacher, and the like are superimposed and displayed. Consequently, the learning terminal 10 requests the notebook data 220 and also generates a notebook template request as will be described next.

In step S656, the notebook terminal 200 requests a notebook template by designating its own apparatus type. It is not necessary for the notebook terminal 200 to generate an acquisition request again when the notebook template has already been acquired.

Then, in step S658, the server 40 selects a notebook template (for example, the notebook template 440-type-A of a format suitable for the learning terminal 10) corresponding to an apparatus type from the notebook templates 440 stored in the teaching material DB 43.

Next, in step S660, the server 40 transmits the notebook template 440-type-A of the format suitable for the learning terminal 10 to the notebook terminal 200.

Then, in step S662, the notebook terminal 200 displays the notebook data 220 including a layer based on the received notebook template 440-type-A on the touch panel 250.

[4-3. Request from Terminal Managing Apparatus 30]

FIG. 20 is a sequence diagram illustrating operation processing when a notebook template request has been generated from the terminal managing apparatus 30. The terminal managing apparatus 30 can browse notebook data 220 of each student as described above.

As illustrated in FIG. 20, in step S670, the terminal managing apparatus 30 detects a notebook page change operation.

Next, in step S672, the terminal managing apparatus 30 generates a request so that the notebook data 220 is transmitted from the communication I/F 304 to the server 40. Then, in step S654, the server 40 extracts the notebook data 220 from the student terminal DB 42 of the content storage unit 403, and transmits the extracted notebook data 220 to the terminal managing apparatus 30.

Here, the notebook data 220 displayed by the terminal managing apparatus 30 is a structure in which a layer of a notebook template serving as a base image and a layer including data input by the student are superimposed and displayed. Consequently, the terminal managing apparatus 30 requests the notebook data 220 of each student and also generates a notebook template request.

In step S676, the terminal managing apparatus 30 generates the notebook template request by designating its own apparatus type. It is not necessary for the terminal managing apparatus 30 to generate an acquisition request again when the notebook template has already been acquired.

Then, in step S678, the server 40 selects a notebook template (for example, the notebook template 440-type-B of a format suitable for the terminal managing apparatus 30) corresponding to an apparatus type from the notebook templates 440 stored in the teaching material DB 43.

Next, in step S680, the server 40 transmits the notebook template 440-type-B of the format suitable for the terminal managing apparatus 30 to the terminal managing apparatus 30.

Then, in step S682, the terminal managing apparatus 30 displays the notebook data 220 including a layer based on the received notebook template 440-type-B on the display apparatus 310.

### 5. CONCLUSION

As described above, in the learning system in accordance with the embodiment of the present disclosure, learning content can be easily customized by selecting/editing a notebook template desired to be used by the teacher in lessons from a plurality of notebook templates created in advance according to teaching materials.

In addition, because writing is performed in a format determined by the student when a predetermined notebook template is used in the lesson, writing content of each student can be obtained in a data structure of the same format. Thereby, the server 40 can perform automatic scoring.

Further, it is possible to analyze improvement of an understanding level of the student or to what extent their studies have progressed when a certain notebook template is used based on accumulated writing content (notebook data) of the same format. Thereby, it is possible to recommend a notebook template more effective for learning to the teacher.

Although preferred embodiments of the present disclosure have been described above in detail with reference to the accompanying drawings, the present technology is not limited to the embodiments. It should be understood by those skilled in the art that various modifications, combinations, sub-combinations and alterations may occur depending on design requirements and other factors insofar as they are within the scope of the appended claims or the equivalents thereof.

For example, the above-described learning terminal 10 has a plurality of housings such as the text terminal 100 and the notebook terminal 200. However, the configuration of the learning terminal 10 in accordance with this embodiment is not limited thereto. For example, the learning terminal 10 may have a single body housing. The learning terminal 10 having the single body housing may divide a display region of a single body touch panel into two parts, control the teaching material data 120 to be displayed in one display region, and control the notebook data 220 to be displayed in the other display region.

In addition, the steps in processing of the learning system of this specification are not necessarily processed in time series in the order described as the sequence diagram. For example, the steps in processing at the initiation of a lesson strafed in FIG. 14 can also be processed in an order different from that described as the sequence diagram or in parallel. More specifically, the notebook AP start-up process shown in step S512 may be performed before the textbook AP start-up instruction process shown in step S508, and these processes may be processed in parallel.

Additionally, the present technology may also be configured as below.

(1) A server including:

a teaching material storage unit configured to store teaching material data, notebook templates, and link information indicating associations between the teaching material data and the notebook templates; and

a transmission unit configured to transmit the teaching material data and the notebook templates associated with the teaching material data to a learning terminal apparatus according to a request from the learning terminal apparatus,

wherein the link information indicates association of a notebook template selected by a teacher for a designated page of the teaching material data, and

wherein the notebook template is superimposed on another layer in the learning terminal apparatus and displayed in the learning terminal apparatus.

(2) The server according to (1), wherein the notebook template is a notebook template edited by the teacher.
(3) The server according to (1) or (2),

wherein the notebook template includes a plurality of formats corresponding to apparatus types, and

wherein the transmission unit transmits the notebook template having a format corresponding to an apparatus type of a request source.

(4) The server according to any one of (1) to (3), wherein the notebook template is image data including a plurality of input components.
(5) The server according to (4), wherein the input component is at least one of a character recognition area, a radio button, or a check box.
(6) The server according to any one of (1) to (5),

wherein the teaching material storage unit further stores test correct answer data,

wherein the server includes
a reception unit configured to receive notebook data from the learning terminal apparatus,
a notebook storage unit configured to store the received notebook data on a per-student basis, and
a scoring unit configured to perform scoring by comparing student written data of a data structure corresponding to the notebook template included in the notebook data with the test correct answer data according to a scoring request from the learning terminal apparatus, and

wherein the transmission unit transmits a scoring result obtained by scoring performed by the scoring unit to the learning terminal apparatus of a scoring request source.

(7) The server according to (6), wherein the scoring result is superimposed on layers of the notebook template and the student written data and displayed in the learning terminal apparatus.
(8) The server according to (6) or (7), further including:

an analysis unit configured to analyze characteristics of each student based on the notebook data; and

a recommendation unit configured to recommend a notebook template having a high learning effect among a plurality of notebook templates based on an analysis result obtained by an analysis performed by the analysis unit.

(9) A learning terminal apparatus including:

a reception unit configured to receive teaching material data and a notebook template associated by a teacher with the teaching material data from a server;

a display control unit configured to control the teaching material data to be displayed in a first display region and control the notebook template associated with the teaching material data displayed in the first display region to be displayed in a second display region; and

an input unit configured to receive data input by a student for the second display region,

wherein the display control unit controls a layer based on the student input data received by the input unit to be superimposed on the notebook template and displayed.

(10) The learning terminal apparatus according to (9), further including:

a transmission unit configured to transmit answer data input by the student for a test notebook template to the server along with a scoring request,

wherein the reception unit receives a scoring result corresponding to the scoring request from the server, and

wherein the display control unit controls a layer of the scoring result to be superimposed on a layer based on the notebook template and the answer data and displayed in the second display region.

(11) The learning terminal apparatus according to (10),

wherein the transmission unit transmits a comment data request to the server when the input unit receives a comment data display instruction of a question, and

wherein the display control unit controls comment data transmitted from the server according to the comment data request to be displayed in the first display region.

(12) A learning content managing method including:

extracting teaching material data and notebook templates associated with the teaching material data from a teaching material storage unit and transmitting the teaching material data and the notebook templates to a learning terminal apparatus, according to a request from the learning terminal apparatus, the teaching material storage unit storing the teaching material data, the notebook templates, and link information indicating associations between the teaching material data and the notebook templates,

wherein the link information indicates association of a notebook template selected by a teacher for a designated page of the teaching material data, and

wherein the notebook template is superimposed on another layer and displayed in the learning terminal apparatus.

The present disclosure contains subject matter related to that disclosed in Japanese Priority Patent Application JP 2012-004935 filed in the Japan Patent Office on Jan. 13, 2012, the entire content of which is hereby incorporated by reference.

What is claimed is:

1. A server comprising:
a teaching material storage unit configured to store teaching material data, notebook templates, and link information indicating associations between the teaching material data and the notebook templates; and
a transmission unit configured to transmit the teaching material data and the notebook templates associated with the teaching material data to a learning terminal apparatus according to a request from the learning terminal apparatus,
wherein the link information indicates association of a notebook template selected by a teacher for a designated page of the teaching material data, and
wherein the notebook template is superimposed on another layer in the learning terminal apparatus and displayed in the learning terminal apparatus.

2. The server according to claim 1, wherein the notebook template is a notebook template edited by the teacher.

3. The server according to claim 1,
wherein the notebook template includes a plurality of formats corresponding to apparatus types, and
wherein the transmission unit, transmits the notebook template having a format corresponding to an apparatus type of a request source.

4. The server according to claim 1, wherein the notebook template is image data including a plurality of input components.

5. The server according to claim 4, wherein the input component is at least one of a character recognition area, a radio button, or a check box.

6. The server according to claim 1,
wherein the teaching material storage unit further stores test correct answer data,
wherein the server includes
a reception unit configured to receive notebook data from learning terminal apparatus,
a notebook storage unit configured to store the received notebook data on a per-student basis, and
a scoring unit configured to perform scoring by comparing student written data of a data structure corresponding to the notebook template included in the notebook data with the test correct answer data according to a scoring request from the learning terminal apparatus, and
wherein the transmission unit transmits a scoring result obtained by scoring performed by the scoring unit to the learning terminal apparatus of a scoring request source.

7. The server according to claim 6, wherein the scoring result is superimposed on layers of the notebook template and the student written data and displayed in the learning terminal apparatus.

8. The server according to claim 6, further comprising:
an analysis unit configured to analyze characteristics of each student based on the notebook data; and
a recommendation unit configured to recommend a notebook template having a high learning effect among a plurality of notebook templates based on an analysis result obtained by an analysis performed by the analysis unit.

9. A learning terminal apparatus comprising:
a reception unit configured to receive teaching material data and a notebook template associated by a teacher with the teaching material data from a server;
a display control unit configured to control the teaching material data to be displayed in a first display region and control the notebook template associated with the teaching material data displayed in the first display region to be displayed in a second display region; and
an input unit configured to receive data input by a student for the second display region,
wherein the display control unit controls a layer based on the student input data received by the input unit to be superimposed on the notebook template and displayed.

10. The learning terminal apparatus according to claim 9, further comprising:
a transmission unit configured to transmit answer data input by the student for a test notebook template to the server along with a scoring request,
wherein the reception unit receives a scoring result corresponding to the scoring request from the server, and
wherein the display control unit controls a layer of the scoring result to be superimposed on a layer based on the notebook template and the answer data and displayed in the second display region.

11. The learning terminal apparatus according to claim 10,
wherein the transmission unit transmits a comment data request to the server when the input unit receives a comment data display instruction of a question, and
wherein the display control unit controls comment data transmitted from the server according to the comment data request to be displayed in the first display region.

12. A learning content managing method comprising:
extracting teaching material data and notebook templates associated with the teaching material data from a teaching material storage unit and transmitting the teaching material data and the notebook templates to a learning terminal apparatus, according to a request from the learning terminal apparatus, the teaching material storage unit storing the teaching material data, the notebook templates, and link information indicating associations between the teaching material data and the notebook templates,
wherein the link information indicates association of a notebook template selected by a teacher for a designated page of the teaching material data, and
wherein the notebook template is superimposed on another layer and displayed in the learning terminal apparatus.
